(19) United States
(12) Patent Application Publication
(10) Pub. No.: US 2026/0191385 A1
(43) Pub. Date: Jul. 9, 2026

(54) ELECTRONIC APPARATUS AND CONTROL METHOD THEREOF

(71) Applicant: Samsung Electronics Co., Ltd., Suwon-si (KR)

(72) Inventors: Hyeokjoo YUN, Suwon-si (KR); Dohyeon AHN, Suwon-si (KR); Yongseok KIM, Suwon-si (KR)

(21) Appl. No.: 19/432,625

(22) Filed: Dec. 24, 2025

Related U.S. Application Data
(63) Continuation of application No. PCT/KR2025/020898, filed on Dec. 5, 2025.

(30) Foreign Application Priority Data
Jan. 3, 2025 (KR) 10-2025-0000835
Feb. 5, 2025 (KR) 10-2025-0014315

(51) Int. Cl. A47L 9/28; G05F 1/66

(52) U.S. Cl. CPC A47L 9/2873; A47L 9/2805; A47L 9/2894; G05F 1/66; A47L 2201/022

(57) ABSTRACT

An electronic apparatus supplying charging power to a robot is provided. The electronic apparatus includes memory, including one or more storage media, storing instructions, a sensor part including a power sensor configured to sense internal power of the electronic apparatus and a docking sensor configured to sense whether the robot is docked, and at least one processor communicatively coupled to the memory and the sensor part, wherein the instructions, when executed by the at least one processor individually or collectively, cause the electronic apparatus to obtain a voltage value through the power sensor, while the electronic apparatus operates in a normal mode configured to perform a charging function on the robot, and change, based on the voltage value being less than a threshold voltage value, the normal mode to a first sleep mode or a second sleep mode according to docking data from the docking sensor, the first sleep mode is a mode in which a charging function is not performed in a state where power is not supplied to the sensor part, and the second sleep mode is a mode in which a charging function is not performed in a state where power is supplied to the sensor part.

### CROSS-REFERENCE TO RELATED APPLICATION

This application is a continuation application, claiming priority under 35 U.S.C. § 365(c), of an International application No. PCT/KR2025/020898, filed on Dec. 5, 2025, which is based on and claims the benefit of a Korean patent application number 10-2025-0000835, filed on Jan. 3, 2025, in the Korean Intellectual Property Office, and of a Korean patent application number 10-2025-0014315, filed on Feb. 5, 2025, in the Korean Intellectual Property Office, the disclosure of each of which is incorporated by reference herein in its entirety.

### BACKGROUND

### 1. Field

The disclosure relates to an electronic apparatus and a control method thereof. More particularly, the disclosure relates to an electronic apparatus supplying charging power to a robot and a control method thereof.

### 2. Description of Related Art

A robot may use power based on a battery. The robot may move by using power stored in the battery. The robot may receive power corresponding to battery capacity from a charging station. The charging station may receive source power from an external power source to charge the robot. The charging station may convert the source power and supply the converted source power to the robot.

The charging station may convert the source power based on a predetermined conversion method. The charging station may supply the converted power to the robot. The charging station may not need to perform all functions, when the charging station does not provide a function of charging the robot.

Even in the case where the charging station does not provide the charging function, high standby power of the charging station may cause a problem, such as a waste of power. At this time, the user may manipulate a power saving mode to prevent such a waste of power. However, this may cause inconvenience to the user. Additionally, in the case where the user manipulates a mode to a power saving mode based on standby time and the like, there may be a problem that even a function required for the charging station is inactivated.

For example, the charging station needs to sense whether the robot is docked, but in the power saving mode, the charging station cannot sense whether the robot is docked.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic apparatus determining a type of sleep mode based on a sensed voltage value and docking data indicating whether a robot is docked, and a control method thereof.

Additional aspects will be set forth in part in the description which follows and, in part, will be apparent from the description, or may be learned by practice of the presented embodiments.

In accordance with an aspect of the disclosure, an electronic apparatus supplying charging power to a robot is provided. The electronic apparatus includes memory, including one or more storage media, storing instructions, a sensor part including a power sensor configured to sense internal power of the electronic apparatus and a docking sensor configured to sense whether the robot is docked, and at least one processor communicatively coupled to the memory and the sensor part, wherein the instructions, when executed by the at least one processor individually or collectively, cause the electronic apparatus to obtain a voltage value through the power sensor, while the electronic apparatus operates in a normal mode configured to perform a charging function on the robot, and based on the voltage value being less than a threshold voltage value, change the normal mode to a first sleep mode or a second sleep mode according to docking data from the docking sensor, wherein the first sleep mode is a mode in which a charging function is not performed in a state where power is not supplied to the sensor part, and wherein the second sleep mode is a mode in which a charging function is not performed in a state where power is supplied to the sensor part.

The instructions, when executed by the at least one processor individually or collectively, further cause the electronic apparatus to identify, based on the voltage value being less than a threshold voltage value, whether the robot is docked according to the docking data, operate, based on identifying that the robot is docked, in the first sleep mode, and operate, based on identifying that the robot is not docked, in the second sleep mode.

The instructions, when executed by the at least one processor individually or collectively, further cause the electronic apparatus to change, based on a predetermined first event group being identified in a state of the first sleep mode, the first sleep mode to the normal mode, and the first event group includes an event in which a command to move the robot is received in a state where the robot is docked.

The instructions, when executed by the at least one processor individually or collectively, further cause the electronic apparatus to change, based on a predetermined second event group being identified in a state of the second sleep mode, the second sleep mode to the normal mode, and the second event group includes at least one of an event in which first threshold time passes from a point in time when the second sleep mode starts, or an event in which the robot in an undocked state is docked.

The second event group includes at least one of an event in which a dust bin cover included in the electronic apparatus is opened, or an event in which a water container cover included in the electronic apparatus is opened.

The electronic apparatus includes a power conversion module configured to convert a source voltage supplied from an external source, and the power conversion module includes a sub processor, a first conversion module configured to supply power to the sub processor, a second conversion module configured to supply power to the sensor part, a third conversion module configured to supply sub charging power to the robot, and a fourth conversion module configured to supply main charging power to the robot.

The instructions, when executed by the at least one processor individually or collectively, further cause the electronic apparatus to change the source voltage to a first voltage through the first conversion module, in a state where the first conversion module is activated, change the source voltage to a second voltage through the second conversion module, in a state where the second conversion module is activated, change the source voltage to a third voltage through the third conversion module, in a state where the third conversion module is activated, and change the source voltage to a fourth voltage through the fourth conversion module, in a state where the fourth conversion module is activated.

The instructions, when executed by the at least one processor individually or collectively, further cause the electronic apparatus to activate the first conversion module and the second conversion module, and activate at least one of the third conversion module or the fourth conversion module, while the electronic apparatus operates in the normal mode.

The instructions, when executed by the at least one processor individually or collectively, further cause the electronic apparatus to activate the first conversion module, and inactivate the second conversion module, the third conversion module and the fourth conversion module, while the electronic apparatus operates in the first sleep mode.

The instructions, when executed by the at least one processor individually or collectively, further cause the electronic apparatus to activate the first conversion module and the second conversion module, and inactivate the third conversion module and the fourth conversion module, while the electronic apparatus operates in the second sleep mode.

In accordance with another aspect of the disclosure, a method of controlling an electronic apparatus supplying charging power to a robot, and including a sensor part including a power sensor configured to sense internal power and a docking sensor configured to sense whether the robot is docked is provided. The method includes obtaining a voltage value through the power sensor, while the electronic apparatus operates in a normal mode configured to perform a charging function on the robot, and based on the voltage value being less than a threshold voltage value, changing the normal mode to a first sleep mode or a second sleep mode according to docking data from the docking sensor, wherein the first sleep mode is a mode in which a charging function is not performed in a state where power is not supplied to the sensor part, and wherein the second sleep mode is a mode in which a charging function is not performed in a state where power is supplied to the sensor part.

The changing of the normal mode includes identifying, based on the voltage value being less than a threshold voltage value, whether the robot is docked according to the docking data, and operating, based on identifying that the robot is docked, in the first sleep mode, and operating, based on identifying that the robot is not docked, in the second sleep mode.

The method includes changing, based on a predetermined first event group being identified in a state of the first sleep mode, the first sleep mode to the normal mode, and the first event group includes an event in which a command to move the robot is received in a state where the robot is docked.

The method includes changing, based on a predetermined second event group being identified in a state of the second sleep mode, the second sleep mode to the normal mode, and the second event group includes at least one of an event in which first threshold time passes from a point in time when the second sleep mode starts, an event in which the robot in an undocked state is docked.

The second event group includes at least one of an event in which a dust bin cover included in the electronic apparatus is opened, or an event in which a water container cover included in the electronic apparatus is opened.

The electronic apparatus includes a power conversion module configured to convert a source voltage supplied from an external source, and the power conversion module includes a sub processor, a first conversion module configured to supply power to the sub processor, a second conversion module configured to supply power to the sensor part, a third conversion module configured to supply sub charging power to the robot, and a fourth conversion module configured to supply main charging power to the robot.

The method includes changing the source voltage to a first voltage through the first conversion module, in a state where the first conversion module is activated, changing the source voltage to a second voltage through the second conversion module, in a state where the second conversion module is activated, changing the source voltage to a third voltage through the third conversion module, in a state where the third conversion module is activated, and changing the source voltage to a fourth voltage through the fourth conversion module, in a state where the fourth conversion module is activated.

The method includes activating the first conversion module and the second conversion module, and activating at least one of the third conversion module or the fourth conversion module, while the electronic apparatus operates in the normal mode.

The method includes activating the first conversion module, and inactivating the second conversion module, the third conversion module and the fourth conversion module, while the electronic apparatus operates in the first sleep mode.

The method includes activating the first conversion module and the second conversion module, and inactivating the third conversion module and the fourth conversion module, while the electronic apparatus operates in the second sleep mode.

In accordance with another aspect of the disclosure, one or more non-transitory computer-readable storage media storing one or more computer programs including computer-executable instructions that, when executed by one or more processors of an electronic apparatus supplying charging power to a robot individually or collectively, cause the electronic apparatus to perform operations are provided. The electronic apparatus includes a sensor part including a power sensor configured to sense internal power and a docking sensor configured to sense whether the robot is docked are provided. The operations include obtaining a voltage value through the power sensor, while the electronic apparatus operates in a normal mode configured to perform a charging function on the robot, and based on the voltage value being less than a threshold voltage value, changing the normal mode to a first sleep mode or a second sleep mode according to docking data from the docking sensor, wherein the first sleep mode is a mode in which a charging function is not performed in a state where power is not supplied to the sensor part, and wherein the second sleep mode is a mode in which a charging function is not performed in a state where power is supplied to the sensor part.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an operation of charging a robot according to an embodiment of the disclosure;

FIG. 2 is a block diagram illustrating an electronic apparatus according to an embodiment of the disclosure;

FIG. 3 is a block diagram illustrating a specific configuration of an electronic apparatus of FIG. 2 according to an embodiment of the disclosure;

FIG. 4 illustrates a server to which a robot is connectable according to an embodiment of the disclosure;

FIG. 5 illustrates a structure of an electronic apparatus according to an embodiment of the disclosure;

FIG. 6 illustrates a structure of an electronic apparatus according to an embodiment of the disclosure;

FIG. 7 illustrates a structure of an electronic apparatus according to an embodiment of the disclosure;

FIG. 8 illustrates a sleep mode according to an embodiment of the disclosure;

FIG. 9 illustrates an electronic apparatus operating in another sleep mode based on whether a robot is docked according to an embodiment of the disclosure;

FIG. 10 illustrates an event in which a sleep mode is converted to a normal mode according to an embodiment of the disclosure;

FIG. 11 illustrates an operation of activating a first conversion module according to an embodiment of the disclosure;

FIG. 12 illustrates a normal mode according to an embodiment of the disclosure;

FIG. 13 illustrates a conversion operation of a normal mode and a sleep mode according to an embodiment of the disclosure;

FIG. 14 illustrates an operation of activating a second conversion module according to an embodiment of the disclosure;

FIG. 15 illustrates an operation of determining whether to activate a third conversion module based on battery remaining capacity a robot according to an embodiment of the disclosure;

FIG. 16 illustrates an operation of identifying a discharged state of a robot according to an embodiment of the disclosure;

FIG. 17 illustrates an operation of charging a robot through a third conversion module after a discharge of the robot according to an embodiment of the disclosure;

FIG. 18 illustrates an operation of supplying a main voltage to a robot according to an embodiment of the disclosure;

FIG. 19 illustrates a conversion operation between a normal mode and a sleep mode according to an embodiment of the disclosure;

FIG. 20 illustrates time for which a sleep mode is performed according to an embodiment of the disclosure;

FIG. 21 illustrates an operation of changing a threshold voltage, threshold time through a server, according to an embodiment of the disclosure;

FIG. 22 illustrates an operation of providing charging information according to an embodiment of the disclosure;

FIG. 23 illustrates an operation of changing conditions associated with a sleep mode according to an embodiment of the disclosure;

FIG. 24 illustrates an operation of displaying a mode of an electronic apparatus according to an embodiment of the disclosure; and

FIG. 25 illustrates a control method of an electronic apparatus according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

General terms currently used as widely as possible are selected as the terms used in the embodiments of the disclosure considering functions in the disclosure, but may be changed based on the intention of those skilled in the art or a judicial precedent, the emergence of a new technology, or the like. In addition, in a certain case, terms arbitrarily chosen by the applicant may be included in the terms used herein. In this case, the meanings of such terms are described in corresponding descriptions of the disclosure. Accordingly, the terms used in the disclosure need to be defined based on the meanings thereof and particulars throughout the disclosure rather than simply names thereof.

In the disclosure, the expression “have”, “may have”, “include”, “may include” or the like, indicates the existence of a corresponding feature (e.g., a numerical value, a function, an operation or an element, such as a part and the like), and does not exclude the existence of an additional feature.

The expression of at least one from A or/and B is to be understood as indicating any one of “A” or “B” or “A and B”.

The expression “1^{st}”, “2^{nd}”, “first”, “second”, or the like, used in the disclosure, may be used to refer to various elements regardless of their order and/or importance, and may be used merely to differentiate one element from another but not intended to limit the elements.

Based on one element (e.g., a first element) referred to as being “(operatively or communicatively) coupled with/to” or “connected with/to” another element (e.g., a second element), it is to be understood that one element may be connected to another element directly, or through yet another element (e.g., a third element).

In the disclosure, the term “include” or “comprised of” and the like specifies the presence of stated features, numbers, steps, operations, elements, components or combinations thereof, but do not imply the exclusion of the presence or addition of one or more other features, numbers, steps, operations, elements, components or combinations thereof.

In the disclosure, the term “module” or “unit” may perform at least one function or operation, and be implemented by hardware or software or by a combination of hardware and software. In addition, a plurality of “modules” or a plurality of “units” may be integrated into at least one module and be implemented by at least one processor except for a “module” or a “unit” that needs to be implemented by specific hardware.

In the disclosure, the term of user may refer to a person who uses an electronic apparatus or an apparatus (e.g., an artificial intelligence electronic apparatus) that uses an electronic apparatus.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

Hereafter, an embodiment according to the disclosure is specifically described with reference to the accompanying drawings.

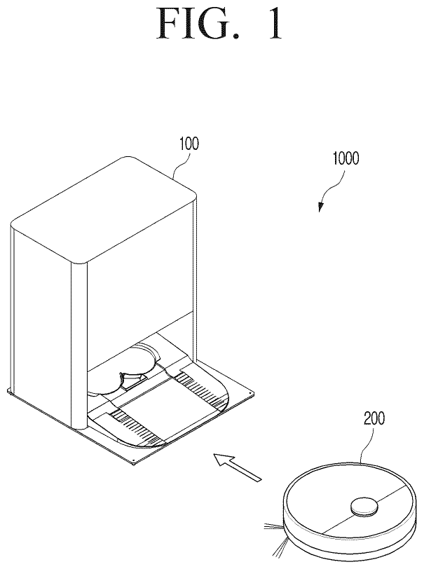

FIG. 1 illustrates an operation of charging a robot according to an embodiment of the disclosure.

Referring to FIG. 1, it illustrates a system 1000 including an electronic apparatus 100 and a robot 200 also referred to as a mobile robot 200 according to an embodiment of the disclosure.

The system 1000 may include an electronic apparatus 100 and a mobile robot 200.

The electronic apparatus 100 may be an apparatus performing a charging function for charging the mobile robot 200. The electronic apparatus 100 may be an apparatus supplying power for charging the mobile robot 200. The electronic apparatus 100 may also be described as a charger or a charging station. The electronic apparatus 100 may receive power from an external power source. The electronic apparatus 100 may supply the received power to the mobile robot 200.

The mobile robot 200 may be a mobile apparatus. The mobile robot 200 may include a power source part. The mobile robot 200 may be an apparatus that can move without being supplied with an external power source. The power source part may include a battery for charging. The mobile robot 200 may move by using power stored in the battery for charging. The mobile robot 200 may also be described as a wireless robot, a mobile electronic apparatus. As one example, the mobile robot 200 may be implemented as one of a robot cleaner, a service robot, a portable projector.

The mobile robot 200 may perform charging by contacting the electronic apparatus 100. As the mobile robot 200 contacts the electronic apparatus 100, the electronic apparatus 100 may supply power to the mobile robot 200. The mobile robot 200 may perform a charging function by using the power received from the electronic apparatus 100.

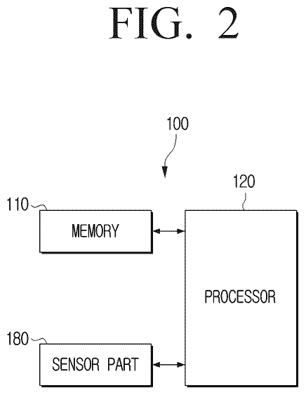

FIG. 2 is a block diagram illustrating an electronic apparatus according to an embodiment of the disclosure.

Referring to FIG. 2, the electronic apparatus 100 may be an apparatus supplying charging power to a robot 200. The electronic apparatus 100 may be a charging apparatus for charging a battery of the robot 200. The robot 200 may be a mobile robot. The robot 200 may move close to the electronic apparatus 100, for charging. The electronic apparatus 100 may also be described as a charging station, a power supply device for charging, a power supply device and the like.

The electronic apparatus 100 may include memory 110 storing instructions, at least one processor 120 including processing circuitry, and a sensor part 180.

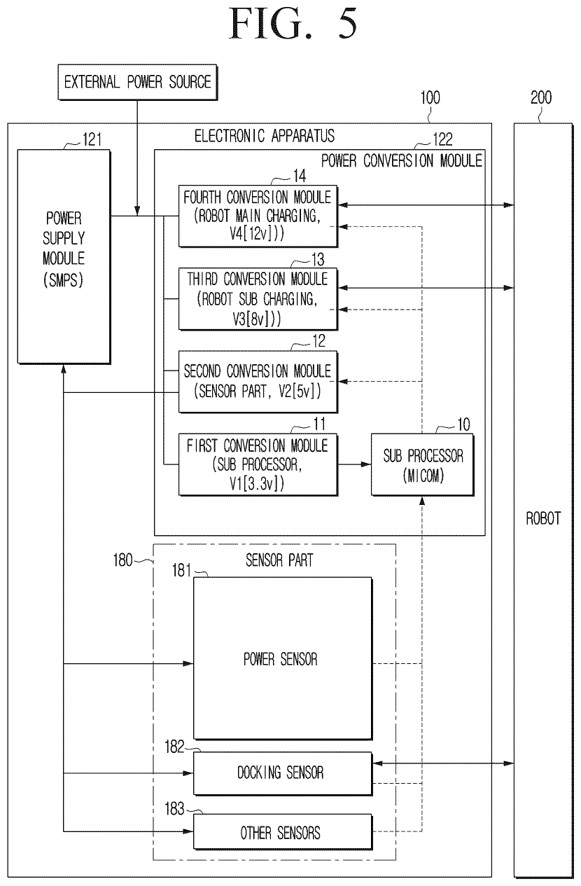

The sensor part 180 may include a power sensor 181 for sensing internal power of the electronic apparatus 100 and a docking sensor 182 for sensing whether the robot 200 is docked. Description in relation to the sensor part 180 is provided with reference to FIGS. 5, 6, and 7.

The at least one processor 120 may operate in a normal mode. The normal mode may denote a mode of performing a function for supplying charging power on the robot 200. The normal mode may be a mode of supplying charging power or a mode of operating in the state where charging power can be supplied.

The at least one processor 120 may obtain a voltage value through the power sensor 181 while operating in the normal mode for performing a charging function on the robot 200. The electronic apparatus 100 may sense a power value of a specific portion of the electronic apparatus 100 through the power sensor 181. The specific portion may be a portion of which a voltage value (or a current value) varies depending on whether the charging function of the electronic apparatus 100 is currently provided. The specific portion may be described as a target portion. The target portion may be changed according to user settings.

The at least one processor 120 may obtain sensing data including a voltage value through the power sensor 181. The at least one processor 120 may compare the voltage value with a threshold voltage value. The at least one processor 120 may determine whether to convert the normal mode to a sleep mode based on a result of the comparison.

The at least one processor 120 may identify whether the voltage value is less than the threshold voltage value. In the case where the voltage value is less than the threshold voltage value, the at least one processor 120 may determine that the electronic apparatus 100 currently does not need to provide a charging function.

In the case where the voltage value is less than the threshold voltage value, the at least one processor 120 may convert the normal mode to a first sleep mode or a second sleep mode based on docking data from the docking sensor 182.

The electronic apparatus 100 may operate in a normal mode or a power saving mode. The normal mode may be a mode of supplying charging power to the robot 200. While operating in the normal mode, the electronic apparatus 100 may remain in the state where the electronic apparatus 100 supplies power to the robot 200, or the electronic apparatus 100 can supply power to the robot 200.

The power saving mode may be a mode for saving power of the electronic apparatus 100. While operating in the power saving mode, the electronic apparatus 100 may operate in the state where the electronic apparatus 100 does not supply power to the robot 200. The electronic apparatus 100 may reduce power consumption by inactivating a module associated with an operation of supplying power to the robot 200.

The electronic apparatus 100 may operate in the normal mode in the case where the electronic apparatus 100 determines that the charging function is required. In the state where the robot 200 is docked to the electronic apparatus 100 and the battery of the robot 200 is not fully charged, the electronic apparatus 100 may determine that the charging function is required.

In the case where the electronic apparatus 100 determines that the charging function is not required, the electronic apparatus 100 may operate in the power saving mode. The power saving mode may include a first sleep mode and a second sleep mode. The first sleep mode and the second sleep mode may be modes for reducing power consumption.

The first sleep mode may be a mode for supplying minimum power. The first sleep mode may be a mode of inactivating both of a module (a second conversion module 12) for supplying power to the sensor part 180 and a module for performing a charging function (e.g., a third conversion module 13, a fourth conversion module 14).

The first sleep mode may be a mode in which the charging function is not performed in the state where power is not supplied to the sensor part 180. The first sleep mode may be a mode in which power is not supplied to the sensor part 180, while the charging function is turned off to save power.

The first sleep mode may be a power saving mode that is performed in the state where the robot 200 is docked. The first sleep mode may be a mode in which the sensor part 180 for sensing whether the robot 200 is docked is inactivated, while the charging function is turned off.

The second sleep mode may be a mode in which the charging function is not performed in the state where power is supplied to the sensor part 180. The second sleep mode may be a mode in which power is supplied to the sensor part 180 while the charging function is turned off to save power.

The second sleep mode may be a mode of activating the module (a second conversion module 12) for supplying power to the sensor part 180 in the first sleep mode. The second sleep mode may be a mode of inactivating the module for performing the charging function while supplying power to the sensor part 180.

The second sleep mode may be a power saving mode that is performed in the state where the robot 200 is not docked. The second sleep mode may be a mode in which the sensor part 180 for sensing whether the robot 200 is docked is activated, while the charging function is turned off.

In the state where the robot 200 is docked to the electronic apparatus 100 and the battery of the robot 200 is fully charged, the electronic apparatus 100 may determine that the charging function is not required. In the state where the robot 200 is docked to the electronic apparatus 100 and the battery of the robot 200 is fully charged, the electronic apparatus 100 may determine that the charging function is not required and that sensing whether the robot 200 is docked is not required. The electronic apparatus 100 may operate in the first sleep mode of inactivating both of the module for a charging function and the module supplying power to the sensor part 180.

In the case where the robot 200 is not docked to the electronic apparatus 100, the electronic apparatus 100 may determine that the charging function is not required. In the case where the robot 200 is not docked to the electronic apparatus 100, the electronic apparatus 100 may determine that power needs to be supplied to the sensor part 180 to activate the docking sensor 182 for identifying whether the robot 200 is docked to the electronic apparatus 100. The electronic apparatus 100 may operate in the second sleep mode of inactivating the charging function while supplying power to the sensor part 180 to sense whether the robot 200 is docked.

In the case where a voltage value obtained through the power sensor 181 is equal to or greater than a threshold voltage value, the electronic apparatus 100 may determine that the charging function is required. In the case where the voltage value is equal to or greater than the threshold voltage value, the electronic apparatus 100 may determine this case as a case where charging power is being supplied to the robot 200 or needs to be supplied to the robot 200.

In the case where a voltage value obtained through the power sensor 181 is less than the threshold voltage value, the electronic apparatus 100 may determine that the charging function is not required. In the case where a sensed voltage value is less than the threshold voltage value, the electronic apparatus 100 may determine that the charging function is not performed.

In the case where a voltage value sensed while the electronic apparatus 100 operates in the normal mode is less than the threshold voltage value, the electronic apparatus 100 may convert the normal mode to the power saving mode.

The power saving mode may include a first sleep mode and a second sleep mode. The first sleep mode and the second sleep mode may be modes for reducing power consumption. The electronic apparatus 100 may perform one of the first sleep mode or the second sleep mode based on whether the robot 200 is docked. In the case where the robot 200 is docked to the electronic apparatus 100, the electronic apparatus 100 may perform the first sleep mode. In the case where the robot 200 is not docked to the electronic apparatus 100, the electronic apparatus 100 may perform the second sleep mode.

The first sleep mode or the second sleep mode may be described as a first power saving mode or a second power saving mode.

In the case where a voltage value is less than the threshold voltage value, the at least one processor 120 may identify whether the robot 200 is docked based on docking data.

In the case where the at least one processor 120 identifies that the robot 200 is docked, the at least one processor 120 may control the electronic apparatus 100 to operate in the first sleep mode.

In the case where the robot 200 is not docked, the at least one processor 120 may control the electronic apparatus 100 to operate in the second sleep mode.

It is identified whether power is supplied or not to the sensor part 180. This is because the possibility that the robot 200 is docked affects a way of supplying power. In the state where the robot 200 is docked, sensing whether the robot 200 is docked is no longer required. In the state where the robot 200 is already docked, the robot 200 may not need to be ready to dock. In the state where the robot 200 is not docked, the robot 200 needs to be ready to dock.

In the case where a voltage value is less than the threshold voltage value, the at least one processor 120 may determine to convert the normal mode to the sleep mode. The at least one processor 120 may determine a type of sleep mode based on docking data.

In the case where the robot 200 is docked in the state where a voltage value is less than the threshold voltage value, the at least one processor 120 may control the electronic apparatus 100 to operate in the first sleep mode.

In the case where the robot 200 is not docked in the state where a voltage value is less than the threshold voltage value, the at least one processor 120 may control the electronic apparatus 100 to operate in the second sleep mode.

In the case where a predetermined first event group is identified in the first sleep mode state, the at least one processor 120 may convert the first sleep mode to the normal mode.

The first event group may include an event in which a command to move the robot 200 is received in the state where the robot 200 is docked.

The at least one processor 120 may identify whether the event in which a command to move the robot 200 is received has occurred.

The user may input a command to move a docked robot 200.

As one example, the robot 200 may receive a command for moving the robot 200 as a user input. As the user command for moving the robot 200 is received, the robot 200 may transmit, to the electronic apparatus 100, a notification signal indicating that the robot 200 receives the command to move. The electronic apparatus 100 may receive the notification signal from the robot 200 through a communication interface 130.

As the at least one processor 120 receives the notification signal, the at least one processor 120 may identify that the event in which a user command for moving the robot 200 is received has occurred.

Since the power of the sensor part 180 is turned off in the first sleep mode, the docking sensor 182 may be in an inactivated state. The at least one processor 120 may not receive the command to move the robot 200 through the docking sensor 182. The at least one processor 120 may identify whether the robot 200 is moved based on the notification signal received through the communication interface 130 rather than the docking sensor 182.

In the case where a predetermined second event group is identified in the second sleep mode state, the at least one processor 120 may convert the second sleep mode to the normal mode.

The second event group may include at least one of an event in which first threshold time passes from a point in time when the second sleep mode starts, an event in which the robot 200 in an undocked state is docked.

The second event group may include at least one of an event in which a dust bin cover included in the electronic apparatus 100 is opened, an event in which a water container cover included in the electronic apparatus 100 is opened.

As one example, the second event group may include at least one of an event in which the dust bin is attached, an event in which the dust bin is detached, an event in which the water container is attached, an event in which the water container is detached.

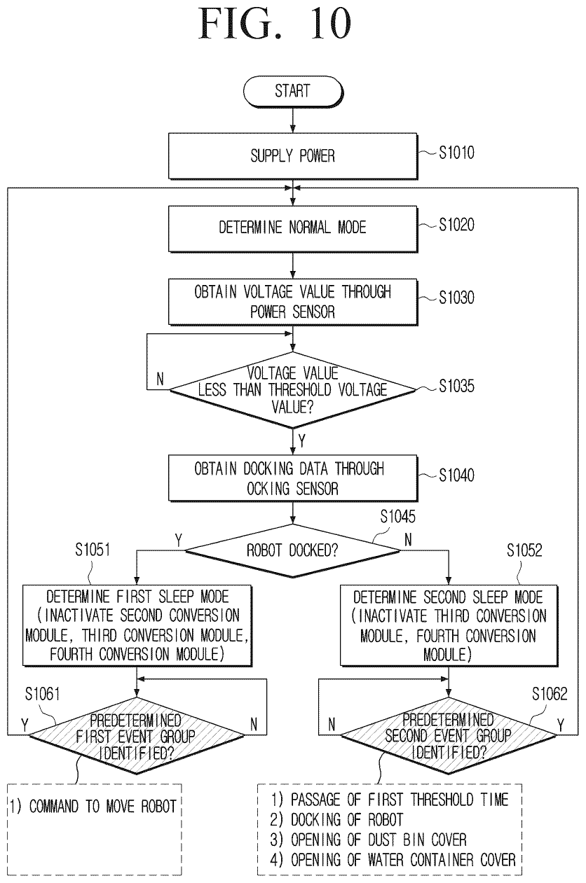

Description in relation to the first event group and the second event group is provided with reference to FIG. 10.

The electronic apparatus 100 may include a power conversion module 122 for converting a source voltage supplied from an external source.

The power conversion module 122 may include a sub processor 10, a first conversion module 11 for supplying power to the sub processor 10, a second conversion module 12 for supplying power to the sensor part 180, a third conversion module 13 for supplying sub charging power to the robot 200 and a fourth conversion module 14 for supplying main charging power to the robot 200.

The sub processor 10 may be a processor controlling at least one module included in the power conversion module 122. The sub processor 10 may be included in the at least one processor 120. The sub processor 10 may be a microcontroller (MICOM).

The at least one module included in the power conversion module 122 may respectively include an integrated circuit.

In the state where the first conversion module 11 is activated, the at least one processor 120 may convert a source voltage to a first voltage through the first conversion module 11.

In the state where the second conversion module 12 is activated, the at least one processor 120 may convert a source voltage to a second voltage through the second conversion module 12.

In the state where the third conversion module 13 is activated, the at least one processor 120 may convert a source voltage to a third voltage through the third conversion module 13.

In the state where the fourth conversion module 14 is activated, the at least one processor 120 may convert a source voltage to a fourth voltage through the fourth conversion module 14.

As one example, the first voltage may be less than the second voltage. The second voltage may be less than the third voltage. The third voltage may be less than the fourth voltage.

The activated state may be described as an on state. The inactivated state may be described as an off state.

The structures of the sub processor 10, the first conversion module 11, the second conversion module 12, the third conversion module 13, and the fourth conversion module 14 are described with reference to FIGS. 5 to 7.

While operating in the normal mode, the at least one processor 120 may activate the first conversion module 11, the second conversion module 12, and activate at least one of the third conversion module 13 or the fourth conversion module 14.

As one example, while operating in the normal mode, the at least one processor 120 may activate the first conversion module 11, the second conversion module 12 and the third conversion module 13.

As one example, while operating in the normal mode, the at least one processor 120 may activate the first conversion module 11, the second conversion module 12 and the fourth conversion module 14.

As one example, while operating in the normal mode, the at least one processor 120 may activate the first conversion module 11, the second conversion module 12, the third conversion module 13 and the fourth conversion module 14.

While operating in the first sleep mode, the at least one processor 120 may activate the first conversion module 11, and inactivate the second conversion module 12, the third conversion module 13 and the fourth conversion module 14.

While operating in the second sleep mode, the at least one processor 120 may activate the first conversion module 11 and the second conversion module 12, and inactivate the third conversion module 13 and the fourth conversion module 14.

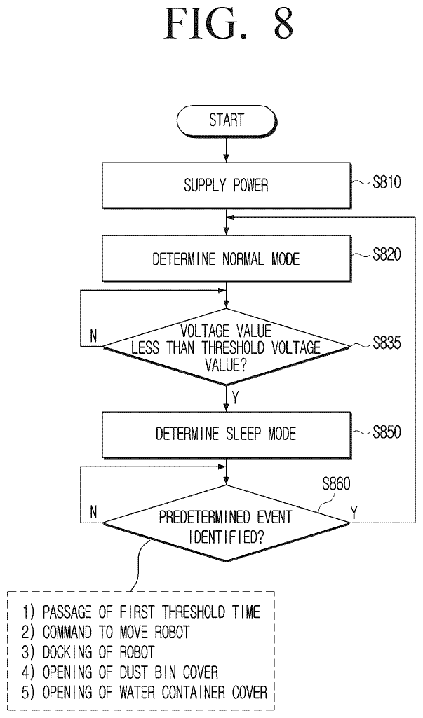

FIG. 8 illustrates a conversion process of a normal mode and the sleep mode.

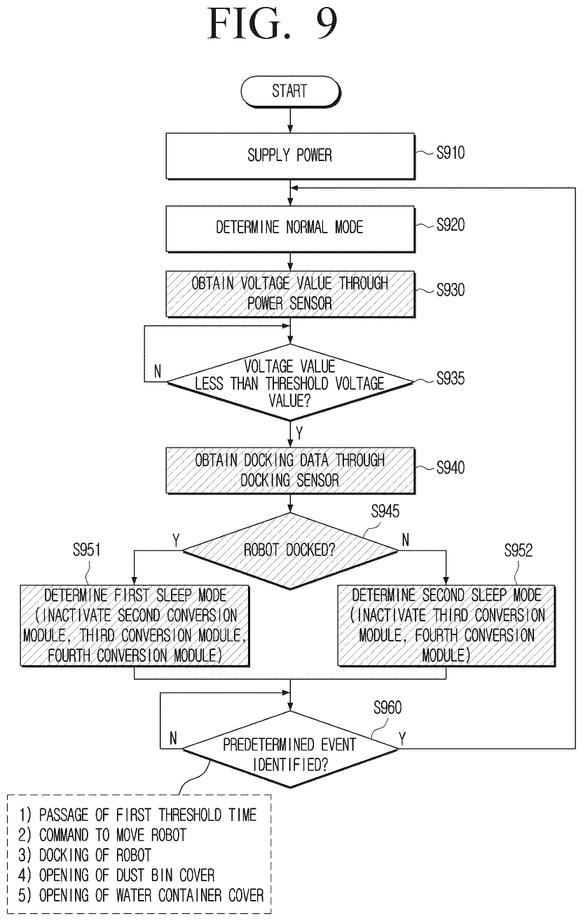

FIGS. 9 and 10 illustrate an operation of differentiating a type of sleep mode based on whether a robot 200 is docked.

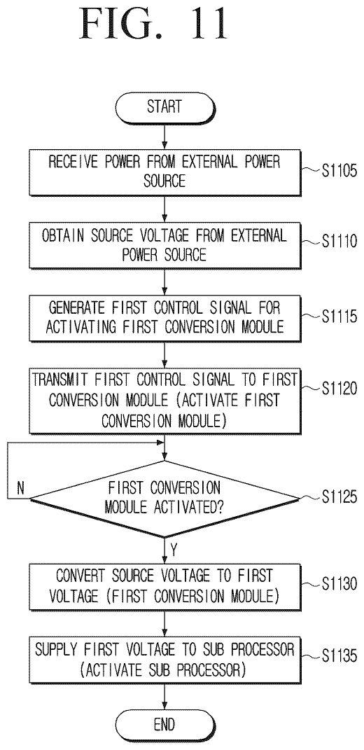

FIG. 11 illustrates operations of an electronic apparatus which are performed in a case where an external power source is supplied.

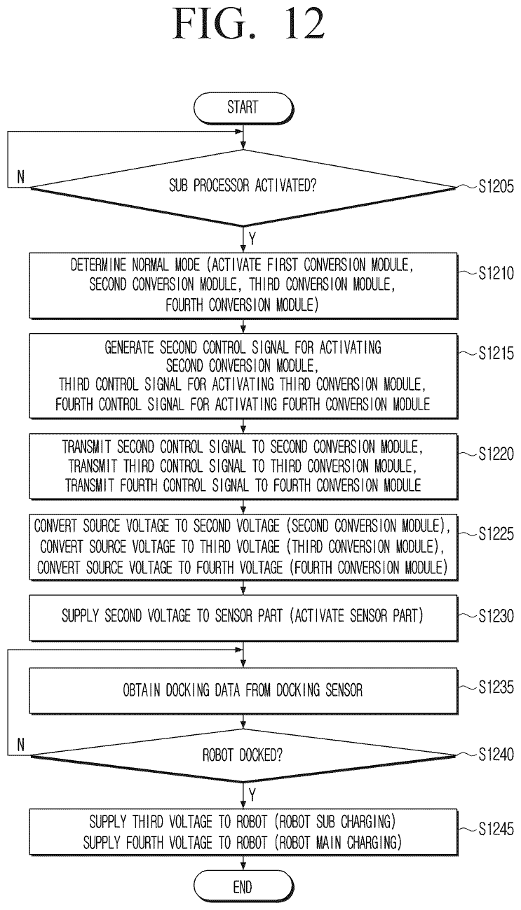

FIG. 12 illustrates an operation of performing a normal mode after an operations of FIG. 11.

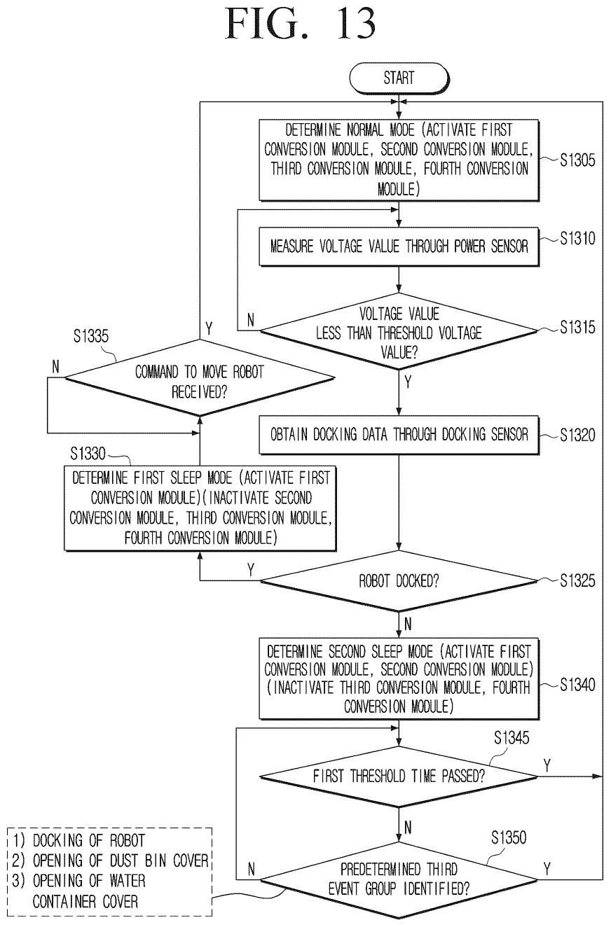

FIG. 13 illustrates a sleep mode conversion operation after a normal mode operation.

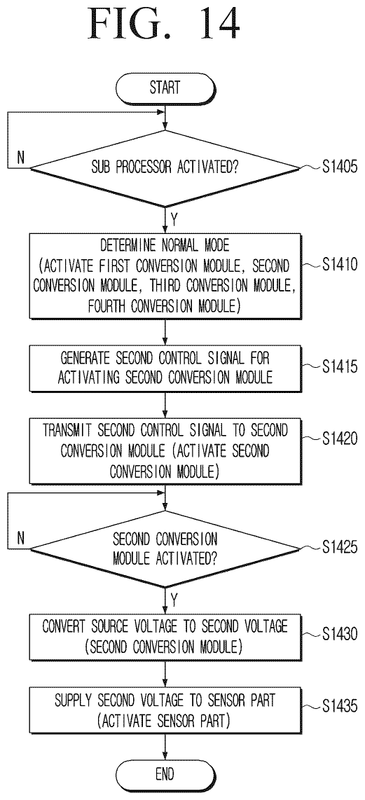

FIG. 12 illustrates the activation operations of the second conversion module 12, the third conversion module 13, and the fourth conversion module 14 at once. However, the activation operations of the second conversion module 12, the third conversion module 13, and the fourth conversion module 14 may be sequentially performed based on detailed operations. Description in relation to this is provided with reference to FIGS. 14 to 18.

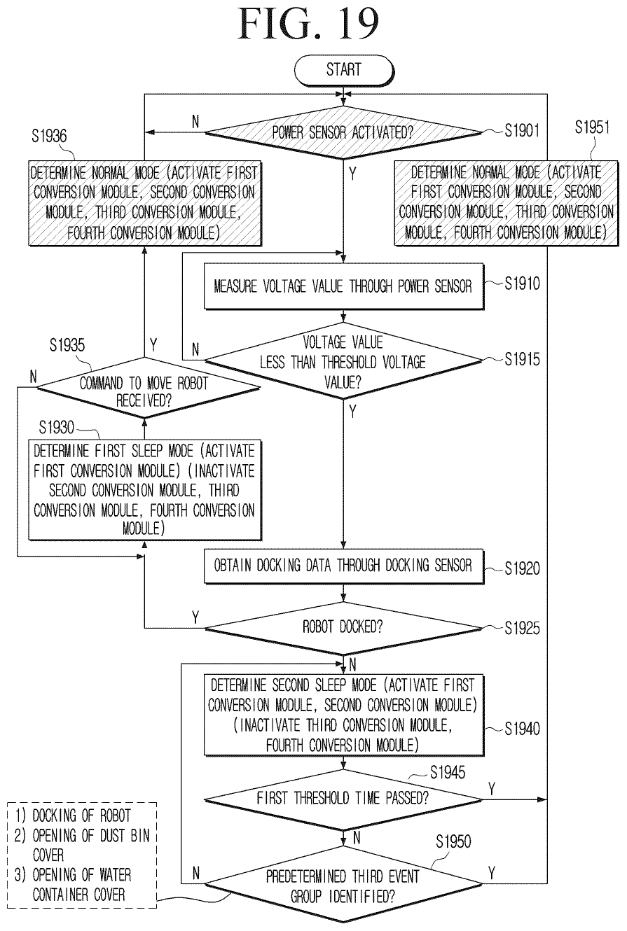

FIG. 19 illustrates an operation of converting a sleep mode in performing the normal mode of FIGS. 14 to 18.

Supplying main charging power of the robot 200 by the first conversion module 11 is described above. According to an embodiment of the disclosure, the first conversion module 11 may perform an additional function in addition to the function of supplying main charging power of the robot 200. The additional function may include at least one of a function of supplying power for performing a UV sterilization function on the robot 200 or a function of supplying power for outputting a docking inducing signal of the robot 200.

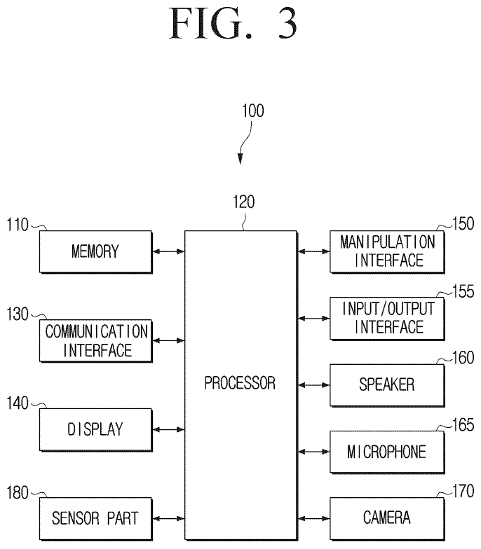

FIG. 3 is a block diagram illustrating a specific configuration of an electronic apparatus of FIG. 2, according to an embodiment of the disclosure.

Referring to FIG. 3, the electronic apparatus 100 may include at least one of memory 110, at least one processor 120, a communication interface 130, a display 140, a manipulation interface 150, an input/output interface 155, a speaker 160, a microphone 165, a camera 170, a sensor part 180.

The memory 110, the at least one processor 120, the communication interface 130, the sensor part 180 may correspond to those described with reference to FIG. 2. Accordingly, description of the elements is avoided.

The memory 110 may be implemented as internal memory, such as read only memory (ROM) (e.g., electrically erasable programmable read-only memory (EEPROM)), random access memory (RAM) and the like included in the at least one processor 120, or as memory separate from the at least one processor 120. The memory 110 may be implemented in the form of memory embedded in the electronic apparatus 100, or in the form of memory detachable from the electronic apparatus 100 depending on a data storage purpose. For example, data for driving the electronic apparatus 100 may be stored in memory embedded in the electronic apparatus 100, and data for an extension function of the electronic apparatus 100 may be stored in memory detachable from the electronic apparatus 100.

The memory embedded in the electronic apparatus 100 may be implemented as at least one of volatile memory (e.g., dynamic RAM (DRAM), static RAM (SRAM) or synchronous dynamic RAM (SDRAM), and the like) or non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., not and (NAND) flash or not or (NOR) flash, and the like), hard drive, or solid state drive (SSD)), and the memory detachable from the electronic apparatus 100 may be implemented in the form of a memory card (e.g., a compact flash (CF), a secure digital (SD), a micro secure digital (Micro-SD), a mini secure digital (Mini-SD), an extreme digital (xD), a multi-media card (MMC), and the like), external memory connectable to a USB port (e.g., USB memory), or the like.

The memory 110 may store at least one instruction. Based on the instruction stored in the memory 110, the at least one processor 120 may perform various operations.

The at least one processor 120 may be implemented as a digital signal processor (DSP) processing a digital signal, a microprocessor, a time controller (TCON). However, the at least one processor 120 is not limited thereto, and may include one or more of a central processing unit (CPU), a micro controller unit (MCU), a micro processing unit (MPU), a controller, an application processor (AP), a graphics-processing unit (GPU) or a communication processor (CP), an advanced reduced instruction set computer (RISC) machine (ARM) processor, or may be defined as such terms. Additionally, the at least one processor 120 may be implemented in the form of a system on a chip (SoC) with an embedded processing algorithm, large scale integration (LSI), or a field programmable gate array (FPGA). The at least one processor 120 may perform various functions by executing computer executable instructions stored in the memory.

The communication interface 130 is an element performing communication with various types of external devices based on various communication methods. The communication interface 130 may include a wireless communication module or a wired communication module. Each of the communication modules may be implemented in the form of at least one hardware chip.

The wireless communication module may be a module communicating with an external device in a wireless manner. For example, the wireless communication module may include at least one of a Wi-Fi module, a Bluetooth module, an infrared communication module, or other communication modules.

The Wi-Fi module and the Bluetooth module may perform communication respectively based on a Wi-Fi method and a Bluetooth method. In the case where the Wi-Fi module or the Bluetooth module is used, various types of connection information, such as a service set identifier (SSID), a session key and the like may be first transmitted and received, and are used to perform communication connection and then transmit and receive various types of information.

The infrared communication module performs communication based on an infrared data association (IrDA) communication technology which transmits data wirelessly over a short distance by using infrared rays between visible light and millimeter waves.

In addition to the above-described communication modules, other communication modules may include at least one communication chip that performs communication according to various wireless communication standards, such as Zigbee, 3^{rd} generation (3G), 3^{rd} generation partnership project (3GPP), long term evolution (LTE), LTE advanced (LTE-A), 4^{th} generation (4G), 5^{th} generation (5G) and the like.

The wired communication module may be a module communicating with an external device in a wired manner. For example, the wired communication module may include at least one of a local area network (LAN) module, an Ethernet module, pair cables, coaxial cables, fiber optic cables or an ultra wide-band (UWB) module.

According to an embodiment of the disclosure, the communication interface 130 may use an identical communication module (e.g., a Wi-Fi module) to perform communication with an external device, such as a remote control device and an external server.

According to an embodiment of the disclosure, the communication interface 130 may use a different communication module to perform communication with an external device, such as a remote control device and an external server. For example, the communication interface 130 may use at least one of the Ethernet module or the Wi-Fi module to perform communication with an external server, or may use a Bluetooth module to perform communication with an external device, such as a remote control device. However, this is described merely as one example, and the communication interface 130 may use at least one of various types of communication modules in the case where the communication interface 130 performs communication with a plurality of external devices or external servers.

The display 140 may be implemented as various types of displays, such as a liquid crystal display (LCD), an organic light emitting diode (OLED) display, a plasma display panel (PDP), and the like. In the display 140, driving circuitry implementable in the form of an amorphous silicon thin film transistor (a-si TFT), a low temperature poly silicon (LTPS) TFT, an organic TFT (OTFT) and the like, a backlight unit, and the like may be included together. The display 140 may be implemented as a touch screen coupled with a touch sensor, a flexible display, a three-dimensional (3D) display, and the like. According to an embodiment of the disclosure, the display 140 may include a bezel housing a display panel as well as a display panel outputting an image. More particularly, according to an embodiment of the disclosure, the bezel may include a touch sensor for sensing a user interaction.

The manipulation interface 150 may be implemented as a device, such as a button, a touch pad, a mouse, and a keyboard, or as touch screen capable of performing the above-described display function and a manipulation input function together. The button may be various types of buttons, such as a mechanical button, a touch pad, a wheel and the like that are formed in any area of the front, side, rear and the like of the exterior of a main body of the electronic apparatus 100.

The input/output interface 155 may be any one interface among high-definition multimedia interface (HDMI), mobile high-definition link (MHL), universal serial bus (USB), display port (DP), Thunderbolt, a video graphics array (VGA) port, an RGB port, D-subminiature (D-SUB), and digital visual interface (DVI). The input/output interface 155 may input and output at least one of an audio signal and a video signal. Depending on embodiments of the disclosure, the input/output interface 155 may include a port inputting and outputting an audio signal only, and a port inputting and outputting a video signal only as separate ports, or may be implemented as one port inputting and outputting both the audio signal and the video signal. The electronic apparatus 100 may transmit at least one of the audio and video signals to an external device (e.g., an external display device or an external speaker) through the input/output interface 155. An output port included in the input/output interface 155 may be connected with an external device, and the electronic apparatus 100 may transmit at least one of the audio and video signals to the external device through the output port.

The input/output interface 155 may be connected with the communication interface. The input/output interface 155 may transmit information received from an external device to the communication interface or transmit information received through the communication interface to the external device.

The speaker 160 may be an element outputting various types of notification sounds or voice messages and the like as well as various types of audio data.

The microphone 165 is an element for receiving an input of a user voice or other sounds, and converting the same to audio data. The microphone 165 may receive a user voice in an activated state. For example, the microphone 165 may be integrally formed on an upper side or in a front surface direction, in a lateral surface direction and the like of the electronic apparatus 100. The microphone 165 may include various types of elements, such as a microphone collecting a user voice in an analogue form, amp circuitry amplifying the collected user voice, analog-to-digital (A/D) conversion circuitry sampling the amplified user voice and converting the same to a digital signal, and filter circuitry removing a noise component from the converted digital signal, and the like.

The camera 170 is an element for capturing an image of a subject and generating a captured image, and the captured image includes both of a moving image and a still image. The camera 170 may obtain an image of at least one external device, and may be implemented with a camera, a lens, an infrared sensor and the like.

The camera 170 may include a lens and an image sensor. The type of lens may include a general-purpose lens, a wide-angle lens, a zoom lens and the like, and may be determined based on the type, feature and operation environment and the like of the electronic apparatus 100. For the image sensor, a complementary metal oxide semiconductor (CMOS), a charge coupled device (CCD) and the like may be used.

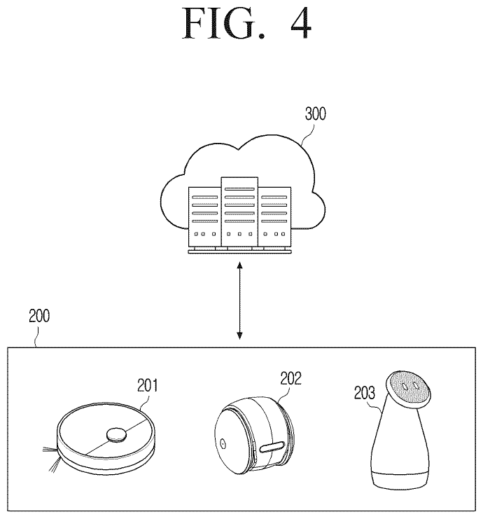

FIG. 4 illustrates a server to which a robot is connectable according to an embodiment of the disclosure.

Referring to FIG. 4, the robot 200 may be connected with a server 300.

As one example, the robot 200 may be implemented as a robot cleaner 201, a mobile projector 202, a mobile service robot 203, and the like.

The robot 200 may be connected with the server 300 for managing the robot 200. The robot 200 may be connected with the server 300 based on a user account. The robot 200 may manage information on the robot 200 through the user account. The robot 200 may use an Internet network to be connected with the server 300.

The server 300 may be a device for managing a terminal device. The server 300 may be an Internet of things (IoT) server or a cloud server. The server 300 may receive the information on the robot 200. The server 300 may transmit a control instruction to the robot 200. The server 300 may transmit a software data packet (e.g., a firmware upgrade packet) associated with the robot 200 to the robot 200.

FIG. 5 illustrates a structure of an electronic apparatus according to an embodiment of the disclosure.

Referring to FIG. 5, the electronic apparatus 100 may include at least one of a power supply module 121, a power conversion module 122, and a sensor part 180.

The power supply module 121 may be a module managing power supplied from an external power source. The power supply module 121 may be implemented as a switching mode power supply (SMPS). The power supply module 121 may perform a power managing function of supplying power efficiently. The power supply module 121 may be a power supply device converting and supplying power efficiently based on a switching technology.

The power supply module 121 may be connected to the power conversion module 122. The power conversion module 122 may include at least one of a sub processor 10, a first conversion module 11, a second conversion module 12, a third conversion module 13, and a fourth conversion module 14.

The power conversion module 122 may convert an external power source. The power conversion module 122 may convert the voltage of an external power source to a predetermined voltage to fit for purpose. The purpose may vary depending on a portion to which a conversion operation is provided.

The first conversion module 11 may convert power that is provided to the sub processor 10. As one example, the first conversion module 11 may convert a source voltage of an external power source to a first voltage.

The second conversion module 12 may convert power that is supplied to the sensor part 180. As one example, the second conversion module 12 may convert a source voltage of an external power source to a second voltage.

The third conversion module 13 may convert power for sub charging of the robot 200. As one example, the third conversion module 13 may convert a source voltage of an external power source to a third voltage.

The fourth conversion module 14 may convert power for main charging of the robot 200. As one example, the fourth conversion module 14 may convert a source voltage of an external power source to a fourth voltage.

As one example, the first voltage may be less than the second voltage. The second voltage may be less than the third voltage. The third voltage may be less than the fourth voltage.

The electronic apparatus 100 may transmit power received from an external power source to the power conversion module 122. The electronic apparatus 100 may activate the sub processor 10 of the power conversion module 122. The sub processor 10 may be supplied with power through the first conversion module 11. The sub processor 10 may control the plurality of modules included in the power conversion module 122. The sub processor 10 may control at least one of the first conversion module 11, the second conversion module 12, the third conversion module 13 and the fourth conversion module 14.

The first conversion module 11 may be a module for supplying power to the sub processor 10. Accordingly, the first conversion module 11 may be in an activated state even in the sleep mode.

While receiving power from the first conversion module 11, the sub processor 10 may control at least one of the second conversion module 12, the third conversion module 13 and the fourth conversion module 14.

The sub processor 10 may activate the second conversion module 12. The second conversion module 12 may convert a source voltage to the second voltage. The converted second voltage may be supplied to the sensor part 180. The electronic apparatus 100 may supply the second voltage to the sensor part 180.

The sensor part 180 may be activated based on the second voltage supplied by the second conversion module 12. The sensor part 180 may include at least one of a power sensor 181, a docking sensor 182, and other sensors 183.

The power sensor 181 may be a sensor for sensing power of a specific portion of the electronic apparatus 100. The power sensor 181 may be a sensor for sensing internal power of the electronic apparatus 100. The electronic apparatus 100 may be connected to an external power source. The electronic apparatus 100 may be an apparatus performing a charging function. In the case where the electronic apparatus 100 is performing the charging function, the electronic apparatus 100 may require an external power source. However, in the case where the electronic apparatus 100 is not performing the charging function, the electronic apparatus 100 may not require an external power source. The electronic apparatus 100 may use the power sensor 181 to sense internal power to differentiate the above-described situations.

The docking sensor 182 may be a sensor for determining whether the robot 200 is docked.

As one example, the docking sensor 182 may physically identify whether the robot 200 is docked. In the case where the robot 200 is contacted physically, the docking sensor 182 may obtain sensing data as to whether the robot 200 is contacted.

As one example, the docking sensor 182 may electrically identify whether the robot 200 is docked. In the case where it is identified that the robot 200 approaches within a threshold distance, the docking sensor 182 may obtain sensing data indicating an electrical change.

As one example, the docking sensor 182 may magnetically identify whether the robot 200 is docked. Assume that the robot 200 includes a magnetic body (or a magnetic object). In the case where the robot 200 is docked, the docking sensor 182 may obtain sensing data indicating a change in the magnetic field.

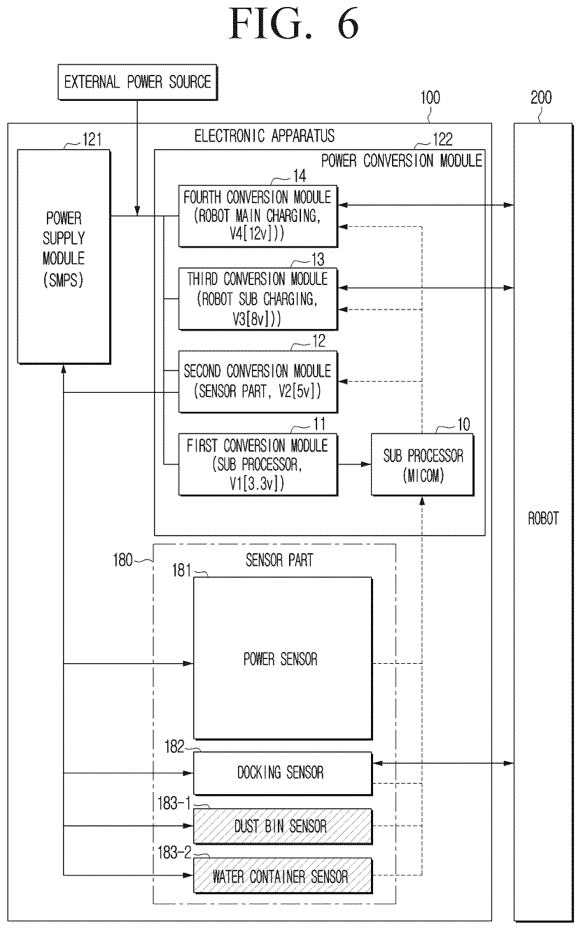

Description of other sensors 183 is provided with reference to FIG. 6.

The sub processor 10 may activate the third conversion module 13. The third conversion module 13 may be a module for supplying an external power source to the robot 200. The third conversion module 13 may perform a function of sub charging of the robot 200. The sub charging function may be a function of supplying minimum power considering a discharged state of the robot 200. Unless the robot 200 is in a discharged state, the supply of power through the third conversion module 13 may not be required.

The sub processor 10 may activate the fourth conversion module 14. The fourth conversion module 14 may be a module for supplying an external power source to the robot 200. The fourth conversion module 14 may perform a function of main charging of the robot 200. The main charging function may be a function of supplying power for charging the robot 200. The main charging function may be a function for charging the battery of the robot 200.

FIG. 6 illustrates a structure of an electronic apparatus according to an embodiment of the disclosure.

Referring to FIG. 6, a power supply module 121, a power conversion module 122, and a sensor part 180 of FIG. 6 may correspond to those of FIG. 5. Accordingly, description of the elements is avoided.

Sensors 183 of FIG. 5 may include at least one of a dust bin sensor 183-1 or a water container sensor 183-2.

The dust bin sensor 183-1 may sense whether the cover of a dust bin is open.

The water container sensor 183-2 may sense whether the cover of a water container is open. The water container may include at least one of a cleaning water container or a contaminated water container.

The sub processor 10 may activate the second conversion module 12. As the second conversion module 12 is activated, the second conversion module 12 may convert a source voltage of an external power source to a second voltage. The second conversion module 12 may supply the second voltage to the sensor part 180. As the second voltage is supplied to the sensor part 180, the electronic apparatus 100 may activate at least one of the dust bin sensor 183-1 or the water container sensor 183-2 included in the sensor part 180.

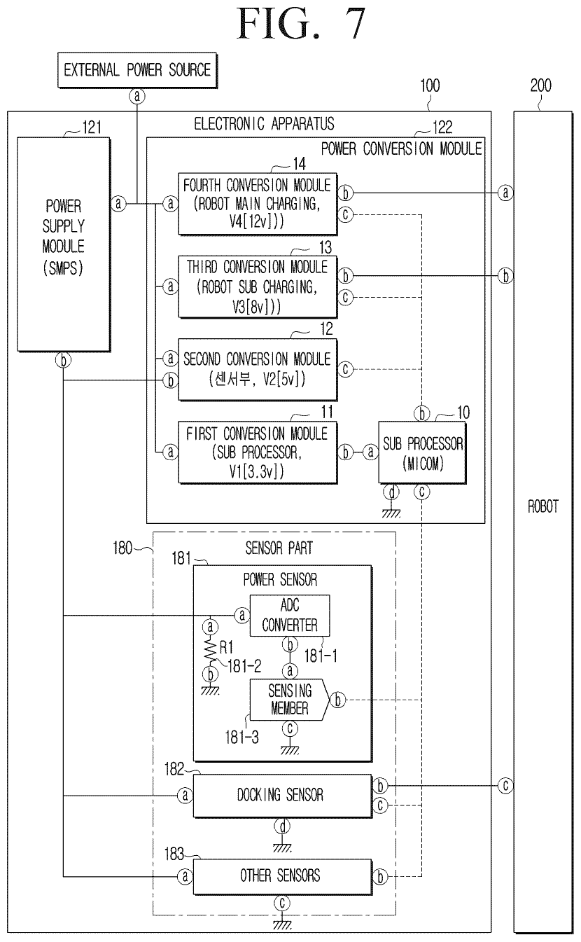

FIG. 7 illustrates a structure of an electronic apparatus according to an embodiment of the disclosure.

Referring to FIG. 7, a power supply module 121, a power conversion module 122 and a sensor part 180 of FIG. 7 may correspond to those of FIG. 5. Accordingly, description of the elements is avoided.

The power sensor 181 may include at least one of an analog-to-digital converter (ADC) 181-1, a target resistance 181-2, and a sensing member 181-3.

The ADC converter 181-1 may convert an analogue signal to a digital signal.

The target resistance 181-2 may be a resistance for identifying current consumption of the electronic apparatus 100. The target resistance 181-2 may be a shunt resistance. The shunt resistance may be a resistance measuring current (or voltage).

The sensing member 181-3 may be a member for identifying power (or a voltage) of a specific portion of the electronic apparatus 100.

A first end (a) of the power supply module 121 may be connected to a first end (a) of an external power source and at least one of a first end (a) of the first conversion module 11, a first end (a) of the second conversion module 12, a first end (a) of the third conversion module 13 and a first end (a) of the fourth conversion module 14.

A second end (b) of the first conversion module 11 may be connected to a first end (a) of the sub processor 10.

A second end (b) of the second conversion module 12 may be connected to at least one of a second end (b) of the power supply module 121 or the sensor part 180.

The second end (b) of the second conversion module 12 may be connected to at least one of the second end (b) of the power supply module 121, a first end (a) of the ADC converter 181-1, a first end (a) of the target resistance 181-2, a first end (a) of the docking sensor 182, and a first end (a) of other sensors 183.

A second end (b) of the third conversion module 13 may be connected to a second end (b) of the robot 200.

A second end (b) of the fourth conversion module 14 may be connected to a first end (a) of the robot 200.

A second end (b) of the ADC converter 181-1 may be connected to a first end (a) of the sensing member 181-3.

A third end (c) of the sensing member 181-3 may be connected to a ground.

A second end (b) of the target resistance 181-2 may be connected to a ground.

A second end (b) of the docking sensor 182 may be connected to a third end (c) of the robot 200.

A third end (c) of other sensors 183 may be connected to a ground.

A second end (b) of the sub processor 10 may be connected to at least one of a third end (c) of the second conversion module 12, a third end (c) of the third conversion module 13, and a third end (c) of the fourth conversion module 14.

A third end (c) of the sub processor 10 may be connected to at least one of a second end (b) of the sensing member 181-3, a third end (c) of the docking sensor 182 and a second end (b) of other sensors 183.

A fourth end (d) of the sub processor 10 may be connected to a ground.

FIG. 8 illustrates a sleep mode according to an embodiment of the disclosure.

Referring to FIG. 8, the electronic apparatus 100 may supply power at operation S810. The electronic apparatus 100 may be supplied with power from an external source. The electronic apparatus 100 may supply a source voltage.

As power is supplied, the electronic apparatus 100 may perform a normal mode at operation S820. The electronic apparatus 100 may operate in the normal mode. The normal mode may be a mode in which the electronic apparatus 100 operates in the state where the electronic apparatus 100 may perform a charging function. The electronic apparatus 100 may activate at least one module required to be ready for charging of the robot 200. The normal mode may be a mode in which at least one module required for a charging function is activated.

The electronic apparatus 100 may identify whether a sensed voltage value is less than a threshold voltage value at operation S835. The electronic apparatus 100 may sense a voltage value through the power sensor 181. Description of the power sensor 181 is provided with reference to FIGS. 5 to 7.

The electronic apparatus 100 may obtain a voltage value through the power sensor 181. The electronic apparatus 100 may compare the voltage value with a pre-stored threshold voltage value.

In the case where the voltage value is less than the threshold voltage value at operation S835-N, the electronic apparatus 100 may determine a sleep mode at operation S860. The electronic apparatus 100 may operate in the sleep mode. The sleep mode may be a mode for saving the power of the electronic apparatus 100. The sleep mode may be a mode of inactivating at least one module activated in the electronic apparatus 100. Based on identical time, power consumed in the sleep mode may be less than power consumed in the normal mode.

While operating in the sleep mode, the electronic apparatus 100 may identify a predetermined event at operation S850. The predetermined event may include an event for ending the sleep mode. The predetermined event may be an event for operating in the normal mode. The predetermined event may be an event for starting the normal mode.

As one example, the predetermined event may include at least one of an event in which first threshold time passes from a point in time when the sleep mode starts, an event in which a command to move the robot 200 is received, an event in which the robot 200 in an undocked state is docked, an event in which the dust bin cover is opened, and an event in which the water container cover is opened.

As the predetermined event occurs at operation S860-Y, the electronic apparatus 100 may determine a normal mode at operation S820. The electronic apparatus 100 may operate in the normal mode. The electronic apparatus 100 may change a current mode from the sleep mode to the normal mode. The electronic apparatus 100 may repeat the operations of S820, S835, S850, S860.

According to another embodiment, the electronic apparatus 100 may obtain a current value rather than a voltage value. The electronic apparatus 100 may compare a current value with a threshold current value. In the case where the current value is less than the threshold current value, the electronic apparatus 100 may determine to perform the sleep mode. The method of using a current value may be applied to describing the drawings provided hereafter, in the same way.

FIG. 9 illustrates an electronic apparatus operating in another sleep mode based on whether a robot is docked according to an embodiment of the disclosure.

Referring to FIG. 9, operations of S910, S920, S935, S960 may correspond to those of S810, S820, S835, S860 in FIG. 8. Accordingly, description of the operations is avoided.

The electronic apparatus 100 may obtain a voltage value through the power sensor 181 at operation S930. The electronic apparatus 100 may sense a voltage value of a predetermined portion through the power sensor 181.

In the case where the voltage value is less than a threshold voltage value operation S935-Y, the electronic apparatus 100 may obtain docking data through the docking sensor 182 at operation S940. The docking data may include sensing data indicating whether the robot 200 is docked to the electronic apparatus 100.

The electronic apparatus 100 may identify whether the robot 200 is docked, based on the docking data at operation S945. In the case where the robot 200 is docked at operation S945-Y, the electronic apparatus 100 may determine a first sleep mode at operation S951. The electronic apparatus 100 may operate in the first sleep mode.

The first sleep mode may be a mode of inactivating at least one of the second conversion module 12, the third conversion module 13 and the fourth conversion module 14. In the first sleep mode, the first conversion module 11 may be activated. As one example, the first sleep mode may be a mode of inactivating the second conversion module 12, the third conversion module 13 and the fourth conversion module 14.

In the case where the robot 200 is not docked at operation S945-N, the electronic apparatus 100 may determine a second sleep mode at operation S952. The electronic apparatus 100 may operate in the second sleep mode.

The second sleep mode may be a mode of inactivating at least one of the third conversion module 13 or the fourth conversion module 14. In the second sleep mode, the first conversion module 11 and the second conversion module 12 may be activated. As one example, the second sleep mode may be a mode of inactivating the third conversion module 13 and the fourth conversion module 14.

While operating in the first sleep mode or the second sleep mode, the electronic apparatus 100 may identify whether a predetermined event occurs at operation S960.

As one example, the predetermined event may include at least one of an event in which first threshold time passes from a point in time when the sleep mode starts, an event in which a command to move the robot 200 is received, an event in which the robot 200 in an undocked state is docked, an event in which the dust bin cover is opened, and an event in which the water container cover is opened.

As the predetermined event occurs at operation S960-Y, the electronic apparatus 100 may determine a normal mode at operation S920. The electronic apparatus 100 may change a current mode from the first sleep mode or the second sleep mode to the normal mode.

FIG. 10 illustrates an event in which a sleep mode is converted to a normal mode according to an embodiment of the disclosure.

Referring to FIG. 10, operations of S1010, S1020, S1030, S1035, S1040, S1045, S1051, S1052 in FIG. 10 may correspond to those of S910, S920, S930, S935, S940, S945, S951, S952 in FIG. 9. Accordingly, description of the operations is avoided.

The predetermined event may include at least one of a predetermined first event group or a predetermined second event group.

The predetermined first event group may indicate an event in which it is determined whether the predetermined event occurs during an operation in the first sleep mode. As one example, the predetermined first event group may include an event in which a command to move the robot 200 is received.

The predetermined second event group may indicate an event in which it is determined whether the predetermined event occurs during an operation in the second sleep mode. As one example, the predetermined second event group may include at least one of an event in which first threshold time passes from a point in time when an operation in the second sleep mode starts, an event in which the robot 200 in an undocked state is docked, an event in which the dust bin cover is opened, and an event in which the water container cover is opened.

While operating in the first sleep mode, the electronic apparatus 100 may identify whether the predetermined first event group occurs at operation S1061. In the case where an event included in the predetermined first event group occurs, the electronic apparatus 100 may change a current mode from the first sleep mode to the normal mode. The electronic apparatus 100 may repeat the operations of S1020, S1030, S1035, S1040, S1045, S1051, S1061.

While operating in the second sleep mode, the electronic apparatus 100 may identify whether the predetermined second event group occurs at operation S1062. In the case where an event included in the predetermined second event group occurs, the electronic apparatus 100 may change a current mode from the second sleep mode to the normal mode. The electronic apparatus 100 may repeat the operations of S1020, S1030, S1035, S1040, S1045, S1051, S1061.

FIG. 11 illustrates an operation of activating a first conversion module according to an embodiment of the disclosure.

Referring to FIG. 11, the electronic apparatus 100 may receive power from an external power source at operation S1105. The electronic apparatus 100 may obtain a source voltage from the external power source at operation S1110.

In the case where the electronic apparatus 100 is connected to the external power source, the electronic apparatus 100 may generate a first control signal for activating the first conversion module 11 at operation S1115. As the electronic apparatus 100 receives the source voltage from the external power source, the electronic apparatus 100 may generate the first control signal.

The electronic apparatus 100 may transmit the first control signal to the first conversion module 11 at operation S1120. The electronic apparatus 100 may activate the first conversion module 11 based on the first control signal. As the first conversion module 11 receives the first control signal, the first conversion module 11 may be activated. The state of the first conversion module 11 may be changed from an inactivated state to an activated state based on the first control signal.

The electronic apparatus 100 may identify whether the first conversion module 11 is activated at operation S1125. As the first conversion module 11 is activated at operation S1125-Y, the electronic apparatus 100 may convert a source voltage to a first voltage at operation S1130. The electronic apparatus 100 may convert the source voltage to the first voltage though the first conversion module 11.

The electronic apparatus 100 may supply the first voltage to the sub processor 10 at operation S1135. The electronic apparatus 100 may activate the sub processor 10 by supplying the first voltage to the sub processor 10. As the sub processor 10 receives the first voltage, the sub processor 10 may be activated.

After the first voltage is supplied to the sub processor 10, the electronic apparatus 100 may perform operations illustrated in FIG. 12 or FIG. 14.

FIG. 12 illustrates a normal mode according to an embodiment of the disclosure.

Referring to FIG. 12, the electronic apparatus 100 may identify whether the sub processor 10 is activated at operation S1205. As the sub processor 10 is activated at operation S1205-Y, the electronic apparatus 100 may determine a normal mode at operation S1210. The normal mode may be a mode of activating at least one module to perform a function of the electronic apparatus 100. The electronic apparatus 100 may provide a charging function in the normal mode.

The electronic apparatus 100 may activate at least one of the first conversion module 11, the second conversion module 12, the third conversion module 13 and the fourth conversion module 14.

As one example, the normal mode may be a mode in which the first conversion module 11, the second conversion module 12 and the third conversion module 13 are activated.

As one example, the normal mode may be a mode in which the first conversion module 11, the second conversion module 12 and the fourth conversion module 14 are activated.

As one example, the normal mode may be a mode in which the first conversion module 11, the second conversion module 12, the third conversion module 13 and the fourth conversion module 14 are activated.

The electronic apparatus 100 may generate at least one of a second control signal for activating the second conversion module 12, a third control signal for activating the third conversion module 13, and a fourth control signal for activating the fourth conversion module 14 at operation S1215.

The electronic apparatus 100 may transmit the second control signal to the second conversion module 12, or transmit the third control signal to the third conversion module 13, or the fourth control signal to the fourth conversion module 14 at operation S1220.

The electronic apparatus 100 may convert a source voltage to at least one of the second voltage, the third voltage and the fourth voltage at operation S1225. The electronic apparatus 100 may convert the source voltage to the second voltage by using the second conversion module 12. The electronic apparatus 100 may convert the source voltage to the third voltage by using the third conversion module 13. The electronic apparatus 100 may convert the source voltage to the fourth voltage by using the fourth conversion module 14.

The electronic apparatus 100 may supply the second voltage to the sensor part 180 at operation S1230. The electronic apparatus 100 may activate the sensor part 180 by supplying the second voltage. The electronic apparatus 100 may activate at least one sensor included in the sensor part 180 by using the second voltage.

The sensor part 180 may include a docking sensor 182. The docking sensor 182 may be a sensor identifying whether the robot 200 is docked to the electronic apparatus 100. The electronic apparatus 100 may obtain docking data from the docking sensor 182 at operation S1235.

The electronic apparatus 100 may identify whether the robot 200 is docked based on the docking data at operation S1240. In the case where the robot 200 is not docked at operation S1240-N, the electronic apparatus 100 may repeat the operations of S1235, S1240.

In the case where the robot 200 is docked at operation S1240-Y, the electronic apparatus 100 may perform at least one of an operation of supplying the third voltage to the robot 200 or an operation of supplying the fourth voltage to the robot 200 at operation S1245.

The electronic apparatus 100 may perform a sub charging function on the robot 200 by supplying the third voltage to the robot 200. The sub charging function may denote charging that is provided in the state where the robot 200 is discharged. The sub charging function may denote low-voltage charging. The sub charging function may include a function of returning to a reliable state by initially charging a completely discharged battery of the robot 200 at a low voltage (or a low current).

The electronic apparatus 100 may perform a main charging function on the robot 200 by supplying the fourth voltage to the robot 200. The main charging function may be a function for charging the battery of the robot 200.

As one example, the electronic apparatus 100 may activate the first conversion module 11, the second conversion module 12, the third conversion module 13 and the fourth conversion module 14. The electronic apparatus 100 may generate a second control signal, a third control signal and a fourth control signal. The electronic apparatus 100 may transmit the second control signal to the second conversion module 12, transmit the third control signal to the third conversion module 13, and transmit the fourth control signal to the fourth conversion module 14. The electronic apparatus 100 may obtain a second voltage, a third voltage and a fourth voltage. In the case where the robot 200 is docked, the electronic apparatus 100 may supply the third voltage and the fourth voltage to the robot 200.

FIG. 13 illustrates a conversion operation of a normal mode and a sleep mode according to an embodiment of the disclosure.

Referring to FIG. 13, the electronic apparatus 100 may determine a normal mode at operation S1305. The normal mode may be a mode in which at least one of the first conversion module 11, the second conversion module 12, the third conversion module 13, and the fourth conversion module 14 is activated. The normal mode may be a mode in which the first conversion module 11 and the second conversion module 12 are activated, and a mode in which at least one of the third conversion module 13 or the fourth conversion module 14 is activated.

The electronic apparatus 100 may measure a voltage value through the power sensor 181 at operation S1310. The electronic apparatus 100 may identify whether the voltage value is less than a threshold voltage value at operation S1315.

In the case where the voltage value is equal to or greater than the threshold voltage value at operation S1315-N, the electronic apparatus 100 may repeat the operations of S1310, S1315.

In the case where the voltage value is less than the threshold voltage value at operation S1315-Y, the electronic apparatus 100 may obtain docking data through the docking sensor 182 at operation S1320. The electronic apparatus 100 may identify whether the robot 200 is docked based on the docking data at operation S1325.

In the case where the robot 200 is docked at operation S1325-Y, the electronic apparatus 100 may determine a first sleep mode. The electronic apparatus 100 may operate in the first sleep mode. The electronic apparatus 100 may change a current mode from the normal mode to the first sleep mode.

The first sleep mode may be a mode of inactivating at least one of the second conversion module 12, the third conversion module 13 and the fourth conversion module 14. In the first sleep mode, the first conversion module 11 may be activated.

As one example, in the first sleep mode, the second conversion module 12, the third conversion module 13 and the fourth conversion module 14 may be inactivated.

While operating in the first sleep mode, the electronic apparatus 100 may identify whether an event in which a command to move the robot 200 is received occurs at operation S1335. The event in which a command to move the robot 200 is received may include a command to move the robot 200 from a charging position to a target position. The command to move the robot 200 may include a command to move to a target position to perform a service function. As one example, the service function may include a cleaning function, an information provision function and the like.

In the case where the event in which a command to move the robot 200 is received is identified at operation S1335-Y, the electronic apparatus 100 may determine a normal mode. The electronic apparatus 100 may change a current mode from the first sleep mode to the normal mode. The electronic apparatus 100 may perform the operations of S1305, S1310, S1315, S1320, S1325, S1330, S1335, S1340, S1345, S1350.

In the case where it is identified that the robot 200 is not docked based on sensing data at operation S1325-N, the electronic apparatus 100 may determine a second sleep mode at operation S1340. The electronic apparatus 100 may operate in the second sleep mode. The electronic apparatus 100 may change a current mode from the normal mode to the second sleep mode.

As one example, the second sleep mode may be a mode in which the first conversion module 11 and the second conversion module 1112 are activated while the third conversion module 13 and the fourth conversion module 14 are inactivated.

The electronic apparatus 100 may identify whether first threshold time passes from a point in time when the second sleep mode starts at operation S1345. The first threshold time may be predetermined time. The first threshold time may vary depending on user settings.

In the case where the first threshold time passes from the point in time when the second sleep mode starts at operation S1345-Y, the electronic apparatus 100 may perform the operations of S1305, S1310, S1315, S1320, S1325, S1330, S1335, S1340, S1345.

In the case where the first threshold time does not pass from the point in time when the second sleep mode starts at operation S1345-N, the electronic apparatus 100 may identify a third predetermined event group at operation S1350. The electronic apparatus 100 may identify whether an event included in the third predetermined event group occurs, while the electronic apparatus 100 operates in the second sleep mode.

As one example, the third predetermined event group may include at least one of an event in which the robot in an undocked state is docked, an event in which the dust bin cover is opened, an event in which the water container cover is opened.

In the case where the third predetermined event group is identified in the second sleep mode at operation S1350-Y, the electronic apparatus 100 may perform the operations of S1305, S1310, S1315, S1320, S1325, S1330, S1335, S1340, S1345, S1350.

In the case where the third predetermined event group is not identified in the second sleep mode at operation S1350-N, the electronic apparatus 100 may perform the operations of S1345, S1350.

FIG. 14 illustrates an operation of activating a second conversion module according to an embodiment of the disclosure.

Referring to FIG. 14, the electronic apparatus 100 may identify whether the sub processor 10 is activated at operation S1405. As the sub processor 10 is activated at operation S1405-Y, the electronic apparatus 100 may determine a normal mode. The electronic apparatus 100 may operate in the normal mode at operation S1410.

As one example, the normal mode may be a mode of activating the first conversion module 11, the second conversion module 12 and activating at least one of the third conversion module 13 or the fourth conversion module 14.

The electronic apparatus 100 may generate a second control signal for activating the second conversion module 12 at operation S1415.

The electronic apparatus 100 may transmit the second control signal to the second conversion module 12 at operation S1420. The electronic apparatus 100 may activate the second conversion module 12 based on the second control signal. As the second conversion module 12 receives the second control signal, the second conversion module 12 may be activated.

The electronic apparatus 100 may identify whether the second conversion module 12 is activated at operation S1425. As the second conversion module 12 is activated at operation S1425-Y, the electronic apparatus 100 may convert a source voltage to the second voltage at operation S1430. The electronic apparatus 100 may supply the second voltage to the sensor part 180 at operation S1435. The electronic apparatus 100 may activate the sensor part 180 by using the second voltage. As the sensor part 180 is supplied with the second voltage, the sensor part 180 may be activated.

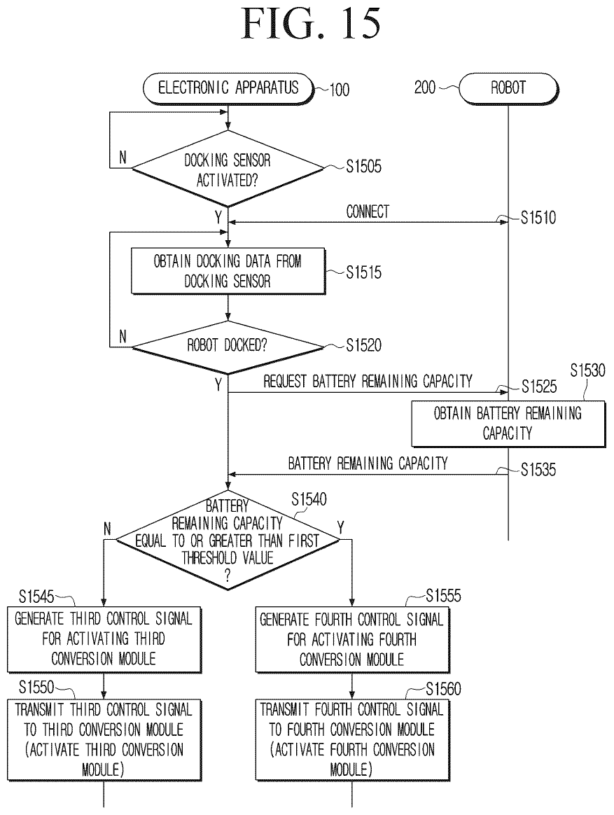

Operations of FIG. 15 may be performed after the operations of FIG. 14.

FIG. 15 illustrates an operation of determining whether to activate a third conversion module based on battery remaining capacity of a robot according to an embodiment of the disclosure.

Referring to FIG. 15, as the second voltage is supplied to the sensor part 180, the electronic apparatus 100 may activate the docking sensor 182. The electronic apparatus 100 may identify whether the docking sensor 182 is activated at operation S1505. As the docking sensor 182 is activated at operation S1505-Y, the electronic apparatus 100 may obtain docking data from the docking sensor 182 at operation S1505.

The electronic apparatus 100 and the robot 200 may be connected at operation S1510. The robot 200 may be docked to the electronic apparatus 100.

The electronic apparatus 100 may identify whether the robot 200 is docked based on the docking data at operation S1520. In the case where the robot 200 is not docked at operation S1520-N, the electronic apparatus 100 may perform the operations of S1515, S1520 repeatedly.

In the case where the robot 200 is docked at operation S1520-Y, the electronic apparatus 100 may request battery remaining capacity from the robot 200 at operation S1525.

The battery remaining capacity may denote remaining charge capacity of the battery included in the robot 200. The battery remaining capacity may also be referred to as a battery charge level, a battery level, battery remaining power, a battery remaining voltage, a battery remaining current and the like.

The robot 200 may receive the request for battery remaining capacity from the electronic apparatus 100. The robot 200 may obtain the battery remaining capacity at operation S1530. The robot 200 may transmit the battery remaining capacity to the electronic apparatus 100 at operation S1535.

The electronic apparatus 100 may receive the battery remaining capacity from the robot 200. The electronic apparatus 100 may identify whether the battery remaining capacity is equal to or greater than a first threshold value at operation S1540.

In the case where the battery remaining capacity is less than the first threshold value at operation S1540-N, the electronic apparatus 100 may generate a third control signal for activating the third conversion module 13 at operation S1545. In the case where the battery remaining capacity is less than the first threshold value at operation S1540-N, the electronic apparatus 100 may determine that a main charging function cannot be performed on the robot 200. The electronic apparatus 100 may determine to perform a sub charging function to supply minimum power to the robot 200.

The electronic apparatus 100 may transmit the third control signal to the third conversion module 13 at operation S1550. The electronic apparatus 100 may activate the third conversion module 13 based on the third control signal. As the third conversion module 13 receives the third control signal, the third conversion module 13 may be activated.

In the case where the battery remaining capacity is equal to or greater than the first threshold value at operation S1540-Y, the electronic apparatus 100 may generate a fourth control signal for activating the fourth conversion module 14 at operation S1555. In the case where the battery remaining capacity is equal to or greater than the first threshold value at operation S1540-Y, the electronic apparatus 100 may determine that the main charging function can be performed on the robot 200.

The electronic apparatus 100 may transmit the fourth control signal to the fourth conversion module 14 at operation S1555. The electronic apparatus 100 may activate the fourth conversion module 14 based on the fourth control signal. As the fourth conversion module 14 receives the fourth control signal, the fourth conversion module 14 may be activated.

In the embodiment of FIG. 15, the electronic apparatus 100 may not activate both the third conversion module 13 and the fourth conversion module 14 at a time. The electronic apparatus 100 may identify a power state of the robot 200, and considering a battery charge level of the robot 200, may activate the third conversion module 13 or the fourth conversion module 14.

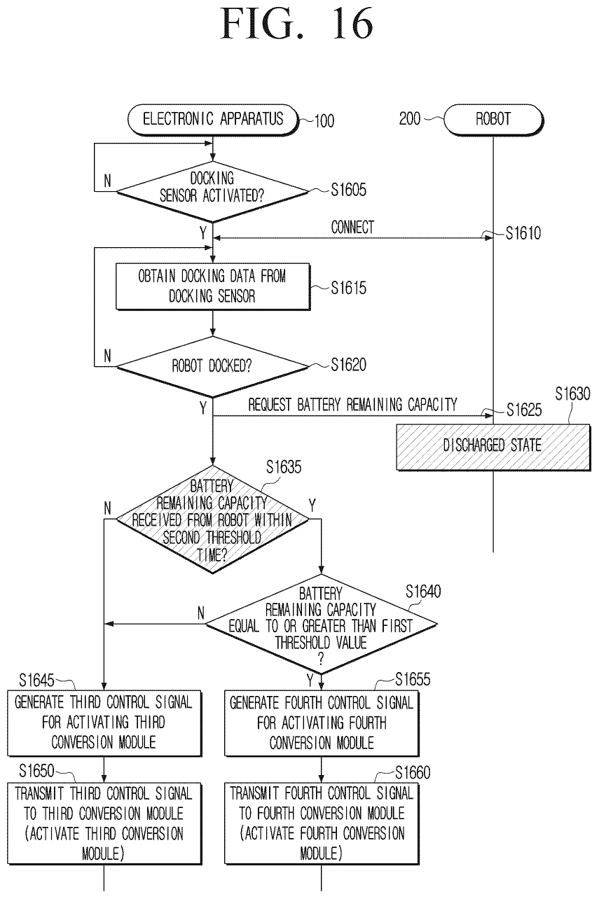

In the case where the third conversion module 13 is activated and the battery remaining capacity of the robot 200 is increased, the electronic apparatus 100 may activate the fourth conversion module 14. Description in relation to this is provided with reference to FIG. 16.

With reference to FIG. 15, an embodiment of transmitting battery remaining capacity by the robot 200 is described. In the case where the robot 200 is completely discharged, it may be difficult to transmit the battery remaining capacity. Description in relation to this is provided with reference to FIG. 16.

FIG. 16 illustrates an operation of identifying a discharged state of a robot according to an embodiment of the disclosure.

Referring to FIG. 16, operations of S1605, S1610, S1615, S1620, S1625, S1640, S1645, S1650, S1655, S1660 in FIG. 16 may correspond to those of S1505, S1510, S1515, S1520, S1525, S1540, S1545, S1550, S1555, S1560 in FIG. 15. Accordingly, description of the operations is avoided.

The electronic apparatus 100 may request battery remaining capacity from the robot 200, but the robot 200 may be in a discharged state at operation S1630. In the case where the robot 200 is in the discharged state, the robot 200 may not receive the request of the electronic apparatus 100 for the battery remaining capacity.

The electronic apparatus 100 may identify whether the electronic apparatus 100 receives the battery remaining capacity from the robot 200 within second threshold time from the point in time when the electronic apparatus 100 requests the battery remaining capacity from the robot 200 at operation S1635.

As the electronic apparatus 100 receives the battery remaining capacity from the robot 200 within the second threshold time from the point in time when the electronic apparatus 100 requests the battery remaining capacity from the robot 200 at operation S1635-Y, the electronic apparatus 100 may perform the operations of S1640, S1645, S1650, S1655, S1660.

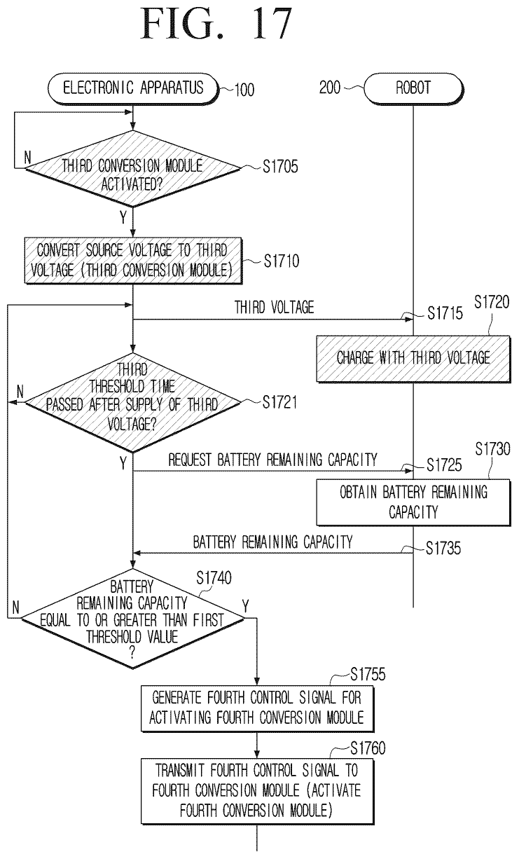

In the case where the electronic apparatus 100 does not receive the battery remaining capacity from the robot 200 within the second threshold time from the point in time when the electronic apparatus 100 requests the battery remaining capacity from the robot 200 at operation S1635-N, the electronic apparatus 100 may generate a third control signal for activating the third conversion module 13 at operation S1645. The electronic apparatus 100 may transmit the third control signal to the third conversion module 13 at operation S1650. The electronic apparatus 100 may activate the third conversion module 13 based on the third control signal. Operations after the activation of the third conversion module 13 are described with reference to FIG. 17.

FIG. 17 illustrates an operation of charging a robot through a third conversion module after a discharge of the robot according to an embodiment of the disclosure.

Referring to FIG. 17, operations of S1725, S1730, S1735, S1740, S1755, S1760 may correspond to those of S1525, S1530, S1535, S1540, S1555, S1560 in FIG. 15. Accordingly, description of the operations is avoided.

The electronic apparatus 100 may identify whether the third conversion module 13 is activated at operation S1705.

The electronic apparatus 100 may identify whether the third conversion module 13 is activated at operation S1705. As the third conversion module 13 is activated at operation S1705-Y, the electronic apparatus 100 may convert a source voltage to a third voltage at operation S1710. The electronic apparatus 100 may convert the source voltage to the third voltage by using the third conversion module 13.

The electronic apparatus 100 may provide the third voltage to the robot 200 at operation S1715.

The robot 200 may receive the third voltage from the electronic apparatus 100. The robot 200 may perform charging (sub charging) based on the third voltage at operation S1720. Based on the charging (sub charging), the battery remaining capacity of the robot 200 may be increased.

The electronic apparatus 100 may identify whether third threshold time passes from a point in time when the third voltage is supplied at operation S1721. The third threshold time may be predetermined time. The third threshold time may vary depending on user settings.

In the case where the third threshold time does not pass after the third voltage is suppled at operation S1721-N, the electronic apparatus 100 may supply the third voltage to the robot 200 continuously.

In the case where the third threshold time passes after the third voltage is supplied at operation S1721-Y, the electronic apparatus 100 may request battery remaining capacity from the robot 200 at operation S1725.

The robot 200 may receive the request for battery remaining capacity from the electronic apparatus 100. The robot 200 may obtain the battery remaining capacity at operation S1730. The robot 200 may transmit the battery remaining capacity to the electronic apparatus 100 at operation S1735.

The electronic apparatus 100 may receive the battery remaining capacity from the robot 200. The electronic apparatus 100 may identify whether the battery remaining capacity is equal to or greater than a first threshold value at operation S1740.

In the case where the battery remaining capacity is less than the first threshold value at operation S1740-N, the electronic apparatus 100 may supply the third voltage to the robot 200 continuously at operation S1715. The electronic apparatus 100 and the robot 200 may perform the operations of S1715, S1720, S1725, S1725, S1730, S1735, S1740 repeatedly.

In the case where the battery remaining capacity is equal to or greater than the first threshold value at operation S1740-Y, the electronic apparatus 100 may generate a fourth control signal for activating the fourth conversion module 14 at operation S1755. The electronic apparatus 100 may transmit the fourth control signal to the fourth conversion module 14 at operation S1760. The electronic apparatus 100 may activate the fourth conversion module 14 based on the fourth control signal. As the fourth conversion module 14 receives the fourth control signal, the fourth conversion module 14 may be activated.

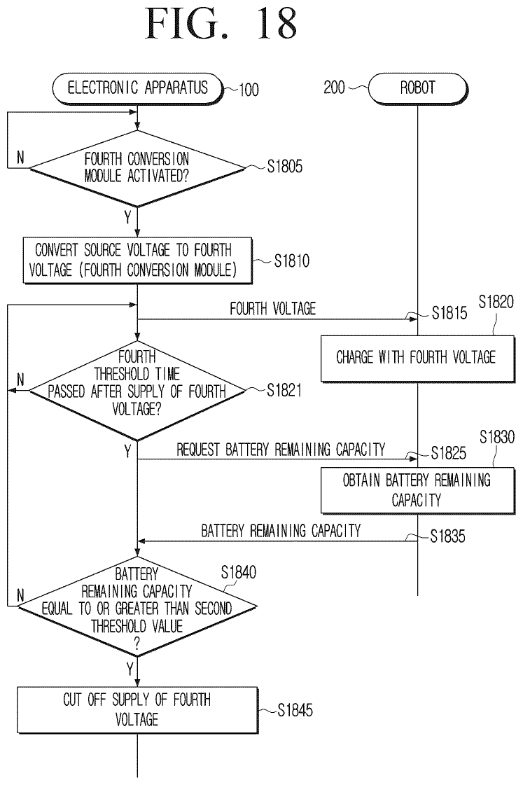

FIG. 18 illustrates an operation of supplying a main voltage to a robot according to an embodiment of the disclosure.

Referring to FIG. 18, the electronic apparatus 100 may identify whether the fourth conversion module 14 is activated at operation S1805. As the fourth conversion module 14 is activated at operation S1805-Y, the electronic apparatus 100 may convert a source voltage to a fourth voltage at operation S1810. The electronic apparatus 100 may supply the fourth voltage to the robot 200 at operation S1815.

The robot 200 may receive the fourth voltage from the electronic apparatus 100. The robot 200 may perform charging (main charging) with the fourth voltage at operation S1820.

The electronic apparatus 100 may identify whether fourth threshold time passes from a point in time when the electronic apparatus 100 supplies the fourth voltage to the robot 200 at operation S1821. The fourth threshold time may be predetermined time. The fourth threshold time may vary depending on user settings.

In the case where the fourth threshold time does not pass after the electronic apparatus supplies the fourth voltage to the robot 200 at operation S1821-N, the electronic apparatus 100 may supply the fourth voltage to the robot 200 continuously.

In the case where the fourth threshold time passes after the electronic apparatus supplies the fourth voltage to the robot 200 at operation S1821-Y, the electronic apparatus 100 may request battery remaining capacity from the robot 200 at operation S1825.

The robot 200 may receive the request for battery remaining capacity from the electronic apparatus 100. The robot 200 may obtain the battery remaining capacity at operation S1830. The robot 200 may transmit the battery remaining capacity to the electronic apparatus 100 at operation S1835.

The electronic apparatus 100 may receive the battery remaining capacity from the robot 200. The electronic apparatus 100 may identify whether the battery remaining capacity is equal to or greater than a second threshold value at operation S1840. The second threshold value may vary depending on user settings. As one example, the second threshold value may be greater than the first threshold value of FIG. 17.

In the case where the battery remaining capacity is not equal to or greater than the second threshold value at operation S1840-N, the electronic apparatus 100 may supply the fourth voltage to the robot 200 continuously. The electronic apparatus 100 and the robot 200 may perform the operations of S1815, S1820, S1821, S1825, S1830, S1835, S1840 repeatedly.

In the case where the battery remaining capacity is equal to or greater than the second threshold value at operation S1840-Y, the electronic apparatus 100 may cut off the supply of the fourth voltage at operation S1845. In the case where the battery remaining capacity is equal to or greater than the second threshold value at operation S1840-Y, the electronic apparatus 100 may identify that the robot 200 is fully charged.

As the robot 200 is fully charged, the electronic apparatus 100 may stop the charging function. Additionally, in the case where the robot 200 is undocked, the electronic apparatus 100 may stop the charging function. In the case where the charging function is stopped, the internal power of the electronic apparatus 100 may be decreased. The electronic apparatus 100 may use the power sensor 181 to identify the internal power. The electronic apparatus 100 may operate in a sleep mode by identifying a voltage value of a specific portion through the power sensor 181. Description in relation to this is provided with reference to FIG. 19.

FIG. 19 illustrates a conversion operation between a normal mode and a sleep mode according to an embodiment of the disclosure.

Referring to FIG. 19, operations of S1910, S1915, S1920, S1925, S1930, S1935, S1940, S1945, S1950 in FIG. 19 may correspond to those of S1310, S1315, S1320, S1325, S1330, S1335, S1340, S1345, S1350 in FIG. 13. Accordingly, description of the operations is avoided.

The electronic apparatus 100 may identify whether the power sensor 181 is activated at operation S1901. As the power sensor 181 is activated at operation S1901-Y, the electronic apparatus 100 may perform the operations of S1910, S1915, S1920, S1925, S1930, S1935, S1936, S1940, S1945, S1950, S1951.

In the case where a command to move the robot 200 is received in the first sleep mode at operation S1935-Y, the electronic apparatus 100 may determine a normal mode. The electronic apparatus 100 may operate in the normal mode. As one example, the electronic apparatus 100 may activate the first conversion module 11 and the second conversion module 12, and activate at least one of the third conversion module 13 or the fourth conversion module 14.

In the case where a predetermined third event group is identified in the second sleep mode at operation S1950-Y, the electronic apparatus 100 may determine a normal mode. The electronic apparatus 100 may operate in the normal mode. As one example, the electronic apparatus 100 may active the first conversion module 11 and the second conversion module 12, and may activate at least one of the third conversion module 13 or the fourth conversion module 14.

The electronic apparatus 100 may perform the operations of S1901, S1910, S1915, S1920, S1925, S1930, S1935, S1936, S1940, S1945, S1950, S1951 after operating in the normal mode.

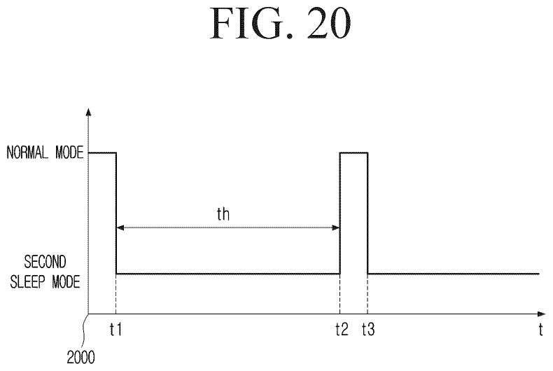

FIG. 20 illustrates time during which a sleep mode is performed according to an embodiment of the disclosure.

Referring to FIG. 20, in an embodiment 2000, the electronic apparatus 100 may operate in the second sleep mode in the state where the robot 200 is not docked. In the case where the electronic apparatus 100 operates in the first sleep mode in the state where the robot 200 is docked, the electronic apparatus 100 may maintain the first sleep mode continuously. However, the electronic apparatus 100 may not maintain the second sleep mode continuously in the state where the robot 200 is not docked. This is to be ready for the situation where the robot 200 is docked.

The electronic apparatus 100 may maintain the second sleep mode during the first threshold time th. As the first threshold time th passes, the electronic apparatus 100 may change a current mode from the second sleep mode to the normal mode.

The electronic apparatus 100 may maintain the second sleep mode during the first threshold time th, from a point in time when the electronic apparatus enters into the second sleep mode from the normal mode. In the case where the predetermined third event group is not identified, the electronic apparatus 100 may maintain the second sleep mode during the first threshold time th. As the first threshold time th passes, the electronic apparatus 100 may operate in the normal mode at a second point in time t2. After operating in the normal mode, the electronic apparatus 100 may determine whether to enter into the second sleep mode. The electronic apparatus 100 may enter into the second sleep mode again at a third point in time t3.

In the embodiment of FIG. 13, the operations of S1340, S1345 may be performed from a first point in time t1 to the second point in time t2. The operations of S1305-S1340 of entering into the normal mode from the second sleep mode may be performed from the second point in time t2 to the third point in time t3.

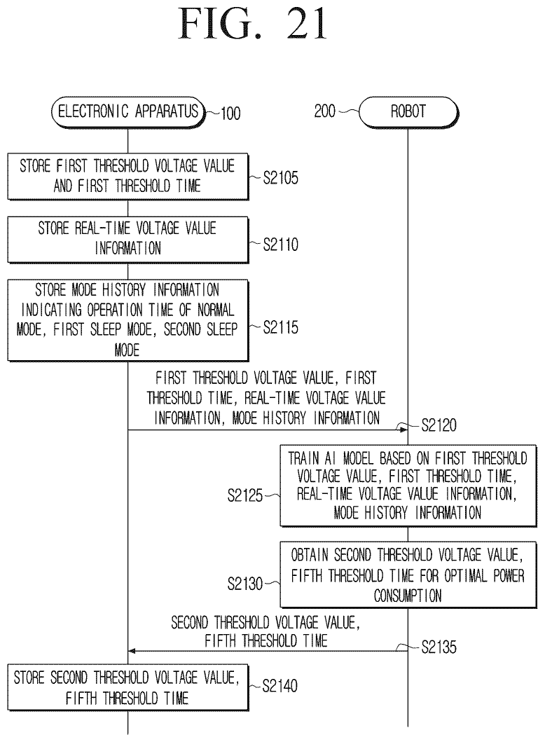

FIG. 21 illustrates an operation of changing a threshold voltage, threshold time through a server according to an embodiment of the disclosure.

Referring to FIG. 21, the robot 200 may be connected with the server 300. The robot 200 may store a first threshold voltage value and first threshold time at operation S2105. The first threshold voltage value may denote the threshold voltage value described with reference to FIGS. 8, 9, 10, 13, and 19.

The robot 200 may store real-time voltage value information at operation S2110. The robot 200 may store the real-time voltage value information obtained through the power sensor 181 of the electronic apparatus 100.

The robot 200 may store mode history information indicating operation time of the normal mode, the first sleep mode, the second sleep mode at operation S2115. The mode history information may include information on time of performing each mode.

The electronic apparatus 100 may obtain the first threshold voltage value, the first threshold time, the real-time voltage value information and the mode history information. The electronic apparatus 100 may transmit the first threshold voltage value, the first threshold time, the real-time voltage value information and the mode history information to the robot 200. The robot 200 may receive the first threshold voltage value, the first threshold time, the real-time voltage value information and the mode history information from the electronic apparatus 100.

The robot 200 may transmit the first threshold voltage value, the first threshold time, the real-time voltage value information and the mode history information to the server 300 at operation S2120.

The server 300 may receive the first threshold voltage value, the first threshold time, the real-time voltage value information and the mode history information from the robot 200. The server 300 may train an artificial intelligence (AI) model based on the first threshold voltage value, the first threshold time, the real-time voltage value information and the mode history information at operation S2125. The AI model may be a model for obtaining an optimal threshold voltage value and optimal threshold time to enhance power efficiency.

The robot 200 may obtain a second threshold voltage value and fifth threshold time for optimal power consumption through the AI model at operation S2130. The robot 200 may transmit the second threshold voltage value and the fifth threshold time to the robot 200.

The robot 200 may receive the second threshold voltage value and the fifth threshold time from the server 300. The robot 200 may transmit the second threshold voltage value and the fifth threshold time to the electronic apparatus 100 at operation S2135.

The electronic apparatus 100 may receive and store the second threshold voltage value and the fifth threshold time from the robot 200 at operation S2140. The electronic apparatus 100 may determine whether to enter into a sleep mode by comparing the second threshold voltage value and a voltage value. The electronic apparatus 100 may determine time of maintaining the second sleep mode based on the fifth threshold time.

In FIG. 21, the robot 200 is connected to the server 300. In another embodiment of the disclosure, the electronic apparatus 100 may be directly connected to the server 300. Identical operations may be performed by the electronic apparatus 100.

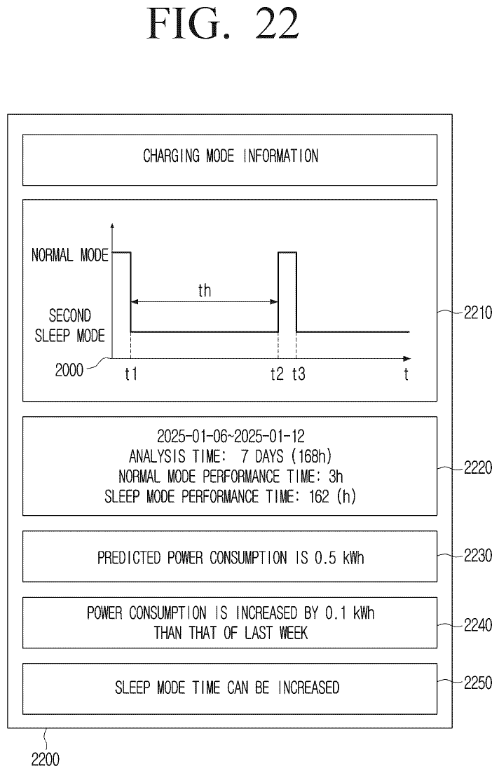

FIG. 22 illustrates an operation of providing charging information according to an embodiment of the disclosure.

Referring to FIG. 22, a screen 2200 associated with a charging mode may be provided. The screen 2200 may include at least one of a user interface (UI) 2210 indicating time of operating in the normal mode, the first sleep mode or the second sleep mode, a UI 2220 indicating a result of analysis of time of operating of each mode, a UI 2230 indicating predicted power consumption, a UI 2240 indicating increased power consumption, a UI 2250 indicating that conditions associated with the sleep mode are changeable.

As one example, the screen 2200 may be provided through a display included in the electronic apparatus 100.

As one example, the screen 2200 may be provided through a display included in the robot 200.

As one example, the screen 2200 may be provided through a display included in a terminal device of the user, which is connected to the electronic apparatus 100 or the robot 200.

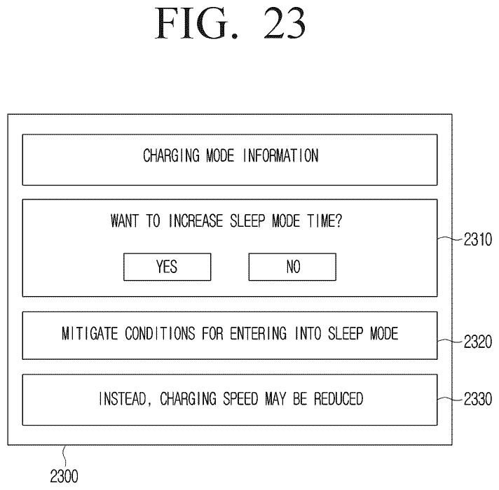

FIG. 23 illustrates an operation of changing conditions associated with a sleep mode according to an embodiment of the disclosure.

Referring to FIG. 23, a screen 2300 for changing conditions associated with the sleep mode may be provided. The screen 2300 may include at least one of a UI 2310 inquiring about increasing time of the sleep mode/inquiring as to whether to increase time of the sleep mode, a UI 2320 indicating that conditions for entering into the sleep mode are changed, a UI 2330 indicating an effect based on a change in the conditions for entering into the sleep mode.

As one example, in the case where the UI 2250 of FIG. 22 is selected, the screen 2300 may be provided.

As described with reference to FIG. 22, the screen 2300 may be provided by at least one of the electronic apparatus 100, the robot 200 and the terminal device of the user, according to various embodiments.

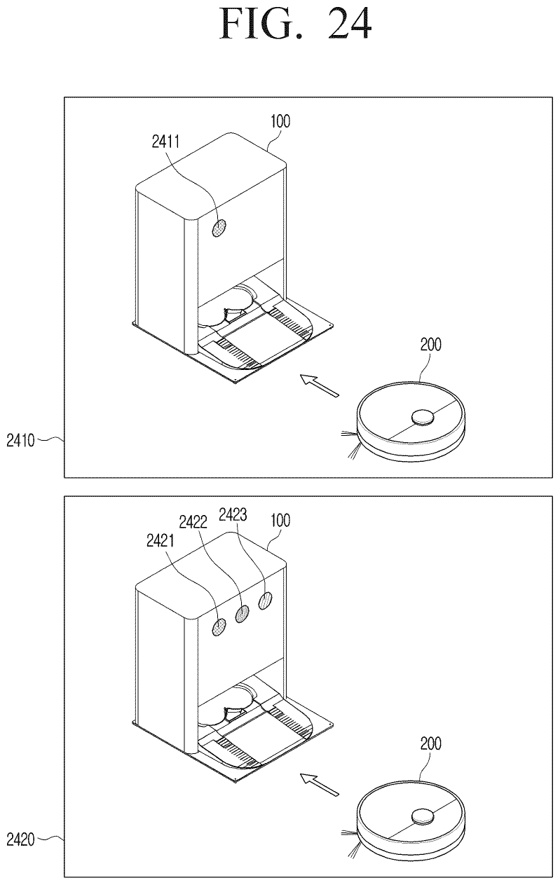

FIG. 24 illustrates an operation of displaying a mode of an electronic apparatus according to an embodiment of the disclosure.

Referring to an embodiment 2420 of FIG. 24, the electronic apparatus 100 may include a light emitting module 2411. The electronic apparatus 100 may control the color of the light emitting module 2411 in a different manner, based on a current mode.

As one example, the electronic apparatus 100 may display the light emitting module 2411 in a predetermined first color, while operating in the normal mode.

As one example, the electronic apparatus 100 may display the light emitting module 2411 in a predetermined second color (different from the first color), while operating in the first sleep mode.

As one example, the electronic apparatus 100 may display the light emitting module 2411 in a predetermined third color (different from the first color), while operating in the second sleep mode.

As one example, the second color may be the same as the third color.

As one example, the second color may be different from the third color.

Referring to the embodiment 2420 of FIG. 24, the electronic apparatus 100 may include a first light emitting module 2421, a second light emitting module 2422, and a third light emitting module 2423.

While operating in the normal mode, the electronic apparatus 100 may display the first light emitting module 2421 in a predetermined fourth color.

While operating in the first sleep mode, the electronic apparatus 100 may display the second light emitting module 2422 in a predetermined fifth color.

While operating in the second sleep mode, the electronic apparatus 100 may display the third light emitting module 2423 in a predetermined sixth color.

As one example, the fourth color, the fifth color, the sixth color may all be different from one another.

According to another embodiment of the disclosure, the electronic apparatus 100 may include a fourth light emitting module and a fifth light emitting module. While operating in the normal mode, the electronic apparatus 100 may display the fourth light emitting module in a seventh color. While operating in the first sleep mode or the second sleep mode, the electronic apparatus 100 may display the fifth light emitting module in an eighth color. As one example, the seventh color and the eighth color may be different from each other.

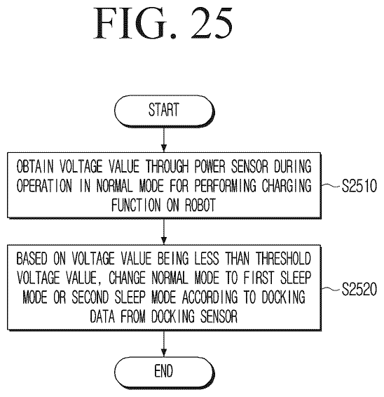

FIG. 25 illustrates a control method of an electronic apparatus according to an embodiment of the disclosure.

Referring to FIG. 25, a control method of an electronic apparatus supplying charging power to a robot 200, and including a sensor part 180 including a power sensor 181 for sensing internal power and a docking sensor 182 for sensing whether the robot 200 is docked, includes (at operation S2510) obtaining a voltage value through the power sensor 181, during an operation in a normal mode for performing a charging function on the robot 200, and (at operation S2520) changing, based on a voltage value being less than a threshold voltage value, the normal mode to a first sleep mode or a second sleep mode according to docking data from the docking sensor 182, and the first sleep mode may be a mode in which a charging function is not performed in the state where power is not supplied to the sensor part 180, while the second sleep mode may be a mode in which a charging function is not performed in the state where power is supplied to the sensor part 180.

The changing the normal mode may include identifying, based on a voltage value being less than a threshold voltage value, whether the robot 200 is docked according to docking data, operating, based on identifying that the robot 200 is docked, in the first sleep mode, and operating, based on identifying that the robot 200 is not docked, in the second sleep mode.

The method may include changing, based on a predetermined first event group being identified in a state of the first sleep mode, the first sleep mode to the normal mode, and the first event group may include an event in which a command to move the robot 200 is received in the state where the robot 200 is docked.

The method may include changing, based on a predetermined second event group being identified in a state of the second sleep mode, the second sleep mode to the normal mode, and the second event group may include at least one of an event in which first threshold time passes from a point in time when the second sleep mode starts, an event in which the robot 200 in an undocked state is docked.

The second event group may include at least one of an event in which the dust bin cover included in the electronic apparatus is opened, an event in which the water container cover included in the electronic apparatus is opened.

The electronic apparatus may include a power conversion module for converting a source voltage supplied from an external source, and the power conversion module may include a sub processor 10, a first conversion module 11 for supplying power to the sub processor 10, a second conversion module 12 for supplying power to the sensor part 180, a third conversion module 13 for supplying sub charging power to the robot 200, and a fourth conversion module 14 for supplying main charging power to the robot 200.

The method may include changing, in an activated state of the first conversion module 11, the source voltage to a first voltage through the first conversion module 11, changing, in an activated state of the second conversion module 12, the source voltage to a second voltage through the second conversion module 12, changing, in an activated state of the third conversion module 13, the source voltage to a third voltage through the third conversion module 13, and changing, in an activated state of the fourth conversion module 14, the source voltage to a fourth voltage through the fourth conversion module 14.

The method may include activating the first conversion module 11, the second conversion module 12, and activating at least one of the third conversion module 13 or the fourth conversion module 14, during an operation in the normal mode.

The method may include activating the first conversion module 11, and inactivating the second conversion module 12, the third conversion module 13 and the fourth conversion module 14, during an operation in the first sleep mode.

The method may include activating the first conversion module 11 and the second conversion module 12, and inactivating the third conversion module 13 and the fourth conversion module 14, during an operation in the second sleep mode.

The methods according to the above-described embodiments may be implemented in the form of an application installable in an existing electronic apparatus.

The methods according to the above-described embodiments may be implemented only by upgrading software or hardware of an existing electronic apparatus.

The above-described embodiments may be performed through an embedded server provided in an electronic apparatus, or an external sever of at least one of an electronic apparatus and a display device.

The embodiments described above may be implemented with software including instructions stored in a storage medium readable by a machine (e.g., a computer). The machine, as a device capable of calling the stored instructions from the storage medium and operating according to the called instructions, may include the electronic apparatus according to the disclosed embodiments. Based on executing instructions by a processor, the processor may perform functions corresponding to the instructions directly or by using other elements under the control of the processor. The instructions may include a code generated or executed by a compiler or an interpreter. The machine-readable storage medium may be provided in the form of a non-transitory storage medium. Herein, the term “non-transitory” only means that the storage medium includes no signal and is tangible while the term does not differentiate semi-permanent or temporary storage of data in the storage medium.

According to the embodiments set forth herein, the method may be provided in a computer program product. The computer program product may be exchanged between a seller and a purchaser as a commodity. The computer program product may be distributed in the form of a machine-readable storage medium (e.g., compact disc read only memory (CD-ROM)), or distributed online through an application store. In the case of online distribution, at least part of the computer program product may be stored at least temporarily, or generated temporarily in a storage medium, such as a manufacturer's server, a server of an application store, or memory of a relay server.

Each of the elements (e.g., a module or a program) according to the embodiments described above may be comprised of a single entity or multiple entities, and some corresponding sub elements described above may be omitted, or another sub element may be further included in the embodiments. Alternatively or additionally, some of the elements (e.g., modules or programs) may be integrated into one entity to perform functions performed by each of the elements prior to the integration in an identical or similar way. Operations performed by a module, a program, or another element, according to the embodiments, may be executed sequentially, in parallel, repetitively, or heuristically, or at least part of the operations may be executed in a different order, may be omitted, or may add a different operation.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic apparatus supplying charging power to a robot, the electronic apparatus comprising:
memory, comprising one or more storage media, storing instructions;
a sensor part including a power sensor configured to sense internal power of the electronic apparatus and a docking sensor configured to sense whether the robot is docked; and
at least one processor communicatively coupled to the memory and the sensor part,
wherein the instructions, when executed by the at least one processor individually or collectively, cause the electronic apparatus to:
obtain a voltage value through the power sensor, while the electronic apparatus operates in a normal mode configured to perform a charging function on the robot, and
based on the voltage value being less than a threshold voltage value, change the normal mode to a first sleep mode or a second sleep mode according to docking data from the docking sensor,
wherein the first sleep mode is a mode in which a charging function is not performed in a state where power is not supplied to the sensor part, and
wherein the second sleep mode is a mode in which a charging function is not performed in a state where power is supplied to the sensor part.

2. The electronic apparatus of claim 1, wherein the instructions, when executed by the at least one processor individually or collectively, further cause the electronic apparatus to:
based on the voltage value being less than a threshold voltage value, identify whether the robot is docked according to the docking data,
based on identifying that the robot is docked, operate in the first sleep mode, and
based on identifying that the robot is not docked, operate in the second sleep mode.

3. The electronic apparatus of claim 2,
wherein the instructions, when executed by the at least one processor individually or collectively, further cause the electronic apparatus to:
based on a first event group being identified in a state of the first sleep mode, change the first sleep mode to the normal mode, and
wherein the first event group includes an event in which a command to move the robot is received in a state where the robot is docked.

4. The electronic apparatus of claim 2,
wherein the instructions, when executed by the at least one processor individually or collectively, further cause the electronic apparatus to:
based on a second event group being identified in a state of the second sleep mode, change the second sleep mode to the normal mode, and
wherein the second event group includes at least one of an event in which first threshold time passes from a point in time when the second sleep mode starts, an event in which the robot in an undocked state is docked.

5. The electronic apparatus of claim 4, wherein the second event group includes at least one of an event in which a dust bin cover included in the electronic apparatus is opened, or an event in which a water container cover included in the electronic apparatus is opened.

6. The electronic apparatus of claim 1, further comprising:
a power conversion module configured to convert a source voltage supplied from an external source,
wherein the power conversion module includes:
a sub processor,
a first conversion module configured to supply power to the sub processor,
a second conversion module configured to supply power to the sensor part,
a third conversion module configured to supply sub charging power to the robot, and
a fourth conversion module configured to supply main charging power to the robot.

7. The electronic apparatus of claim 6, wherein the instructions, when executed by the at least one processor individually or collectively, further cause the electronic apparatus to:
change the source voltage to a first voltage through the first conversion module, in a state where the first conversion module is activated,
change the source voltage to a second voltage through the second conversion module, in a state where the second conversion module is activated,
change the source voltage to a third voltage through the third conversion module, in a state where the third conversion module is activated, and
change the source voltage to a fourth voltage through the fourth conversion module, in a state where the fourth conversion module is activated.

8. The electronic apparatus of claim 6, wherein the instructions, when executed by the at least one processor individually or collectively, further cause the electronic apparatus to:
activate the first conversion module and the second conversion module, and activate at least one of the third conversion module or the fourth conversion module, while the electronic apparatus operates in the normal mode.

9. The electronic apparatus of claim 6, wherein the instructions, when executed by the at least one processor individually or collectively, further cause the electronic apparatus to:
activate the first conversion module, and inactivate the second conversion module, the third conversion module and the fourth conversion module, while the electronic apparatus operates in the first sleep mode.

10. The electronic apparatus of claim 6, wherein the instructions, when executed by the at least one processor individually or collectively, further cause the electronic apparatus to:
activate the first conversion module and the second conversion module, and inactivate the third conversion module and the fourth conversion module, while the electronic apparatus operates in the second sleep mode.

11. A method of controlling an electronic apparatus supplying charging power to a robot, and comprising a sensor part including a power sensor configured to sense internal power and a docking sensor configured to sense whether the robot is docked, the method comprising:
obtaining a voltage value through the power sensor, while the electronic apparatus operates in a normal mode configured to perform a charging function on the robot; and
based on the voltage value being less than a threshold voltage value, changing the normal mode to a first sleep mode or a second sleep mode according to docking data from the docking sensor,
wherein the first sleep mode is a mode in which a charging function is not performed in a state where power is not supplied to the sensor part, and
wherein the second sleep mode is a mode in which a charging function is not performed in a state where power is supplied to the sensor part.

12. The method of claim 11, wherein the changing of the normal mode includes:
based on the voltage value being less than a threshold voltage value, identifying whether the robot is docked according to the docking data;
based on identifying that the robot is docked, operating in the first sleep mode; and
based on identifying that the robot is not docked, operating in the second sleep mode.

13. The method of claim 12,
wherein the method includes, based on a first event group being identified in a state of the first sleep mode, changing the first sleep mode to the normal mode, and
wherein the first event group includes an event in which a command to move the robot is received in a state where the robot is docked.

14. The method of claim 12, further comprising:
based on a second event group being identified in a state of the second sleep mode, changing the second sleep mode to the normal mode,
wherein the second event group includes at least one of an event in which first threshold time passes from a point in time when the second sleep mode starts, or an event in which the robot in an undocked state is docked.

15. The method of claim 14, wherein the second event group includes at least one of an event in which a dust bin cover included in the electronic apparatus is opened, or an event in which a water container cover included in the electronic apparatus is opened.

16. The method of claim 11, further comprising:
converting, by a power conversion module, a source voltage supplied from an external source,
wherein the power conversion module includes:
a sub processor,
a first conversion module configured to supply power to the sub processor,
a second conversion module configured to supply power to the sensor part,
a third conversion module configured to supply sub charging power to the robot, and
a fourth conversion module configured to supply main charging power to the robot.

17. The method of claim 16, further comprising:
changing the source voltage to a first voltage through the first conversion module, in a state where the first conversion module is activated;
changing the source voltage to a second voltage through the second conversion module, in a state where the second conversion module is activated;
changing the source voltage to a third voltage through the third conversion module, in a state where the third conversion module is activated; and
changing the source voltage to a fourth voltage through the fourth conversion module, in a state where the fourth conversion module is activated.

18. The method of claim 16, further comprising:
activating the first conversion module and the second conversion module, and activating at least one of the third conversion module or the fourth conversion module, while the electronic apparatus operates in the normal mode.

19. One or more non-transitory computer-readable storage media storing one or more computer programs including computer-executable instructions that, when executed by one or more processors of an electronic apparatus supplying charging power to a robot individually or collectively, cause the electronic apparatus to perform operations, the electronic apparatus comprising a sensor part including a power sensor configured to sense internal power and a docking sensor configured to sense whether the robot is docked, the operations comprising:
obtaining a voltage value through the power sensor, while the electronic apparatus operates in a normal mode configured to perform a charging function on the robot; and
based on the voltage value being less than a threshold voltage value, changing the normal mode to a first sleep mode or a second sleep mode according to docking data from the docking sensor,
wherein the first sleep mode is a mode in which a charging function is not performed in a state where power is not supplied to the sensor part, and
wherein the second sleep mode is a mode in which a charging function is not performed in a state where power is supplied to the sensor part.

20. The one or more non-transitory computer-readable storage media of claim 19, wherein the changing of the normal mode includes:
based on the voltage value being less than a threshold voltage value, identifying whether the robot is docked according to the docking data;
based on identifying that the robot is docked, operating in the first sleep mode; and
based on identifying that the robot is not docked, operating in the second sleep mode.
